(19) United States
(12) Patent Application Publication
(10) Pub. No.: US 2012/0154980 A1
(43) Pub. Date: Jun. 21, 2012

(54) CONDUCTIVE POLYMER COMPOSITES

(75) Inventors: Patrick J. Kinlen, Fenton, OH (US); June-Ho Jung, Springfield, MO (US); Young-Gi Kim, Springfield, MO (US); Joseph Mbugua, Springfield, MO (US)

(73) Assignee: LUMIMOVE, INC., D/B/A CROSSLINK, St. Louis, MO (US)

(21) Appl. No.: 12/948,636

(22) Filed: Nov. 17, 2010

Related U.S. Application Data
(60) Provisional application No. 61/261,869, filed on Nov. 17, 2009.

(51) Int. Cl. H01G 9/155; H01G 9/058; H01B 1/24; B82Y 99/00; B82Y 30/00

(52) U.S. Cl. 361/502; 252/511; 977/742; 977/948; 977/752

(57) ABSTRACT

The invention is directed, in an embodiment, to an inherently conductive polymer comprising a conductive polymer, carbon nanotubes, and dinonylnaphthalene sulfonic acid. The conductive polymer may comprise polyaniline. The invention is also directed to polymeric films and supercapacitors comprising the inherently conductive polymer.

The present application claims priority to U.S. Provisional Patent Application Ser. No. 61/261,869, filed Nov. 17, 2009, which is incorporated herein by reference in its entirety.

This invention was made with government support under Contract Award NNK055MA92P, awarded by the John F. Kennedy Space Center, National Aeronautics and Space Administration (Kennedy Space Center, FL) and Contract No. W15QKN-07-C-0121, Mod. #P00001, awarded by the U.S. Army, Armament Research, Development and Engineering Center (Picatinny, N.J.). The Government has certain rights in the invention.

### BACKGROUND OF THE INVENTION

The present invention relates to highly conductive polymer composite materials.

### SUMMARY OF THE INVENTION

In an embodiment, the invention is directed to an inherently conductive polymer comprising a conductive polymer, carbon nanotubes, and a primary dopant.

In another embodiment, the invention is directed to an inherently conductive polymeric film comprising a conductive polymer, carbon nanotubes, and a primary dopant.

In yet another embodiment, the invention is directed to a supercapacitor comprising: a first substrate comprising a first and second surface; a first electrode having a first and second side, wherein the first side is adjacent the second surface of the first substrate, and comprising an intrinsically conductive polymer, carbon nanotubes, and a primary dopant; an electrolyte adjacent the second side of the first electrode; a second electrode having a first side and a second side, wherein the first side is adjacent the second side of the first electrode and separated from the first electrode by the electrolyte, and comprising an intrinsically conductive polymer, carbon nanotubes, and a primary dopant; and a second substrate having a first surface and a second surface, wherein the first surface is adjacent the second side of the second electrode.

### BRIEF DESCRIPTION OF THE DRAWINGS

FIG. 1 illustrates polyaniline (PANI) conductivity as a function of single wall carbon nanotube (SWCNT) loading.

FIG. 2 illustrates the conductivities of PANI with and without functionalized carbon nanotubes (CNTs).

FIG. 3 illustrates UV-vis-NIR spectra of (A) Formula A and (B) Formula 1.

FIG. 4 illustrates a plot of conductivity versus % CNT in PANI/CNT composites prepared using emulsion polymerization.

FIG. 5 illustrates a plot of conductivity versus % CNT in secondary doped PANI/CNT composites prepared using emulsion polymerization.

FIG. 6 illustrates a plot of conductivity versus % CNT in secondary doped PANI/CNT composites prepared using emulsion polymerization.

FIG. 7 illustrates a plot of conductivity versus % CNT in secondary doped PANI/CNT composites prepared using emulsion polymerization.

FIG. 8 illustrates four-probe conductivity bar graphs of doped PANI/CNT composites.

FIG. 9 illustrates the UV vis NIR-spectra of sulfonyl diphenol (SDP) doped PANI/CNT Formula A and Formula B.

FIG. 10 illustrates the UV vis NIR-spectra of SDP doped Formula BS and additionally p-toluenesulfonic acid (PTSA)/p-toluenesulfonamide (PTSAM) doped Formula BS.

FIG. 11 illustrates a cyclic voltammetry (CV) diagram of (left) PANI/CNT Formula A, Formula A doped by PTSA/PTSAM and Formula 2 by doping at 50 mV/s in 1.0 M H₂SO₄; and (right) EMPAC™ 1007, doped EMPAC™ 1007, doped formula AS and doped formula BS at 100 mV in 1.0 M H₂SO₄.

FIG. 12 illustrates a CV diagram of Formula 7 (left) scan rate-dependent CV of Formula 7 film on Au interfacial layer (IFL) onto stainless steel (SS) at various scan rates; and (right) a plot of current versus scan rate in Formula 7.

FIG. 13 illustrates a CV diagram of Formula 8 (left) scan rate-dependent CV of Formula 8 film on Au IFL onto SS at various scan rates; and (right) a plot of current versus scan rate in Formula 8.

FIG. 14 illustrates chronocoulometry of Formula 7 and Formula 8.

FIG. 15 illustrates a CV diagram of Formula B (left) scan rate dependent CV of Formula B film on Au IFL onto SS at various scan rates; and (right) a plot of current at Formula B oxidative potential versus scan rate.

FIG. 16 illustrates a CV diagram of secondary doped formula B (Left-top) scan rate-dependent CV of formula B film on Au IFL onto SS at various scan rates; (right-top) redox stability of secondary doped formula B; (left-bottom) a plot of current (A) at secondary doped formula B oxidative potential versus scan rate; and (right-bottom) a plot of SC (F/g) versus scan rate.

FIG. 17 illustrates chronocoulometry of Formula B and secondary doped Formula B.

FIG. 18 illustrates a CV diagram of Formula 1 (left) scan rate-dependent CV of Formula 1 film on Au IFL onto SS at various scan rates; and (right) a plot of current versus scan rate in Formula 1.

FIG. 19 illustrates chronocoulometry of PTSA/PTSAM doped Formula 1.

FIG. 20 illustrates CV diagram of Formula 2 (left) scan rate-dependent CV of Formula 2 film on Au IFL onto SS at various scan rates; and (right) a plot of current versus scan rate in Formula 2.

FIG. 21 illustrates the electro-characterization of EMPAC™ 1007 in 1M H₂SO₄. (A) Scan rate dependent CV of EMPAC™ 1007 film on Au IFL onto SS at various scan rates; (B) chronocoulometry of EMPAC™ 1007; (C) plot of current versus scan rate; and (D) plot of Specific capacitance (F/g) versus scan rate.

FIG. 22 illustrates electro-characterization of PTSA/PTSAM doped EMPAC™ 1007 in 1M H₂SO₄. (A) CV diagram of scan rate dependent CV of EMPAC™ 1007 film on Au IFL onto SS at various scan rates; (B) chronocoulometry diagram; (C) plot of current versus scan rate; and (D) plot of specific capacitance (F/g) versus scan rate.

FIG. 23 illustrates electro-characterization of PTSA/PTSAM doped Formula AS in 1M H₂SO₄. (A) CV diagram of scan rate dependent CV of Formula AS film on Au IFL onto SS at various scan rates; (B) chronocoulometry diagram; (C) plot of current versus scan rate; and (D) plot of specific capacitance (F/g) versus scan rate.

FIG. 24 illustrates galvanostatic charge-discharge curve of PTSA/PTSAM doped Formula AS in 1M H₂SO₄.

FIG. 25 illustrates electro-characterization of PTSA/PTSAM doped Formula BS in 1M H₂SO₄. (A) CV diagram of scan rate dependent CV of Formula BS film on Au IFL onto SS at various scan rates; (B) chronocoulometry diagram; (C) plot of current versus scan rate; (D) plot of specific capacitance (F/g) versus scan rate.

FIG. 26 illustrates galvanostatic charge-discharge curve of PTSA/PTSAM doped Formula BS in 1M H₂SO₄.

FIG. 27 illustrates device performance of coin cells containing electrodes composed of PTSA-PTSAM secondary-doped Formula A (0.1% CNT).

FIG. 28 illustrates the proposed mechanism of aniline polymerization in situ CNT dispersion in water.

FIG. 29 illustrates the surface conductivity of PANI/CNT formula thin film with various CNT amounts.

FIG. 30 illustrates (left) galvanostatic charge-discharge (C-DC) stability of PANI/CNT(1.0%) in 1M H₂SO₄; (right) potential sweet redox stability of PANI/CNT (0.1%) in 0.2 M tetrabutyl ammonium perchlorate (TBAP)/acetonitrile (ACN).

FIG. 31 illustrates the redox stability of secondary doped EMPAC™ 1003 in various electrolytes.

FIG. 32 illustrates the redox stability of poly(4,8-bis(2,3-dihydrothieno-[3,4-b][1,4]dioxin-5-yl)benzo[1,2-c4,5-c′]bis[1,2,5]thiadiazole) (POLY(BEDOT-BBT)) in various electrolytes.

FIG. 33 illustrates (left) CV of electrochemical deposition of BEDOT-BBT on carbon paper for 3 cycles using potential sweep method at −0.4 V to 0.9 V (versus Ag/AgNO3); (right) electro-characterization oncarbon paper and polymer coated carbon paper in 0.2 M TBAP/ACN at 50 mV/s.

FIG. 34 illustrates a plot of current (mA) at 0.4 V versus potential sweep scan rate.

FIG. 35 illustrates a SEM image of porous carbon fabric, carbon paper and Poly(BEDOT-BBT) deposited carbon papers.

FIG. 36 illustrates a digital photograph of a T-cell.

FIG. 37 illustrates (left) electro-characterization of carbon paper and polymer coated carbon paper in 0.5M bis(trifluoromethane)sulfonimide lithium salt (LiBTI) in 1-ethyl-3-methylimidazolium bis(triflouromethylsulfonyl)imide (EMI-IM)/propylene carbonate (PC) at 50 mV/s; (right) redox stability of type III T-cell supercapacitor.

FIG. 38 illustrates (left) CV plot of capacitance versus potential under different scan rate (right) redox stability of type III T-cell supercapacitor.

FIG. 39 illustrates the CV diagram of POLY(BEDOT-BBT)/carbon paper electrode made by chemical polymerization.

FIG. 40 illustrates a diagram of an embodiment of a coin cell of the present invention.

FIG. 41 illustrates the CV curves of coin cells using CNT layer/metallic EMPAC™ 1003 (left) versus metallic EMPAC 1003™ layer (right).

FIG. 42 illustrates the C-DC profile of coin cells using CNT layer/metallic EMPAC™ 1003 (top) versus metallic EMPAC™ 1003 layer (bottom).

FIG. 43 illustrates the C-DC profile comparison of coin cells using CNT layer/metallic EMPAC™ 1003 versus metallic EMPAC™ 1003 layer at the 3^{rd} 1000 cycles.

FIG. 44 illustrates a comparison of open cell performance using an Arbin tester (obtained at the 10^{th} of 1000 cycles of C-DC process).

FIG. 45 illustrates the capacity profiles of an open cell that used a CNT-EMPAC™ 1003 composite layer over 10,000 C-DC cycles.

FIG. 46 illustrates replicated capacity profiles of an open cell that used a CNT-EMPAC™ 1003 composite over 10,000 C-DC cycles.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

As used herein, the terms “inherently conductive polymer” (ICP), or “conductive polymer” refer to an organic polymer that contains polyconjugated bond systems and which may be doped with electron donor dopants or electron acceptor dopants to form a ionic pairing complex that has an electrical conductivity of at least about 10⁻⁸ S/cm. It will be understood that whenever an ICP or conductive polymer is referred to herein, it is meant that the material is associated with a dopant.

The term “dopant”, as used herein, means any protonic acid that forms a salt with a conductive polymer to give an electrically conductive form of the polymer. A single acid may be used as a dopant, or two or more different acids can act as the dopant for a polymer.

The term “film”, as used herein in conjunction with the description of a conductive polymer, means a solid form of the polymer. Unless otherwise described, the film can have almost any physical shape and is not limited to sheet-like shapes or to any other particular physical shape. Commonly, a film of a conductive polymer can conform to the surface of the dielectric layer of a solid electrolyte capacitor.

The term “composite”, as used here, refers to a physical material having a nanostructure provided by carbon nanotubes and conductive polymers.

The term “mixture”, as used herein, refers to a physical combination of two or more materials and includes, without limitation, solutions, dispersions, emulsions, micro-emulsions, and the like.

The present invention, in an embodiment, is directed to conductive materials that could be utilized in supercapacitors, low cost circuits, displays for power devices, microelectromechanical systems, photovoltaic devices, opto-electronic devices, solar cells, field effect transistors, light emitting diodes, electrochromic devices, non-volatile memories, fuel cells, batteries, space exploration devices, or any other system or device requiring conductive materials. More specifically, the invention relates to highly conductive polymers and ICPs. The inventors have developed soluble, solution processible ICPs based on conductive polymers which may be directly spin coated, spray coated, draw down coated, drop cast or screen printed onto a variety of substrates.

Although any conductive polymer can be used in the present invention, examples of useful polymers include polyaniline (PANI), polypyrrole, polyacetylene, polythiophene, poly(phenylene vinylene), and the like. Polymers of substituted or unsubstituted aniline, pyrrole, or thiophene can serve as the conductive polymer of the present invention. For ease of discussion, the invention may be described with reference to polyaniline films. Those having ordinary skill in the art will recognize the invention is applicable to films of other ICPs and the invention shall not be limited to polyaniline films.

In some embodiments, the conductive polymer utilized is PANI. PANI is an ICP considered a suitable candidate for application as electrode material in energy storage devices, including supercapacitors. PANI exhibits good stability and film-forming capability. Additionally, PANI exhibits good electrochemical properties such as faradaic capacitance and charge-discharge capability.

Basic PANIs have a conductivity of approximately 25 S/cm. In some embodiments of the present invention, however, the conductivity of the PANI conductive films has been increased from about 25 S/cm to between about 40 and 50 S/cm. In some embodiments, the inventive composites can have conductivity between about 25 and 100 S/cm. In other embodiments, the inventive composites can have conductivity between about 30 and 75 S/cm. In still other embodiments, the inventive composites can have conductivity between about 40 and 60 S/cm.

In a particular embodiment, the inventors have developed a highly conductive composite by incorporating CNTs into PANI-dinonylnaphthalene sulfonic acid (DNNSA) films. In this embodiment, DNNSA is utilized as the primary dopant. In an embodiment, the DNNSA may be Nacure® 1051. In other embodiments, various protonic acids may be used as dopants for conductive polymers, such as PANI. For example, simple protonic acids such as HCl and H₂SO₄, functionalized organic protonic acids such as p-toluenesulfonic acid (PTSA), or dodecylbenzenesulfonic acid (DBSA) result in the formation of conductive polyaniline.

The PANI utilized herein may be any polyaniline known in the art. In some embodiments, EMPAC™ 1003 or EMPAC™ 1007, commercial products of Crosslink, may be utilized. EMPAC™ 1003 is a primary-doped polyaniline solution that employs DNNSA as the primary dopant. EMPAC™ 1003 has a room temperature electrical conductivity of 0.16 S/cm. EMPAC™ 1007 is a solution “in-situ” secondary doped EMPAC™ 1003 with a room temperature electrical conductivity of 15-20 S/cm. Thus, if utilizing EMPAC™ 1003 or EMPAC™ 1007, it would be unnecessary to additionally add DNNSA.

In an embodiment, the CNT may be any CNT known in the art. In some embodiments, the CNTs may be multi-walled CNTs (MWCNTs) or SWCNTs. For example, the CNTs could be CNTRENE™ C100 CNTs available from Brewer Science, Inc., P5-SWNT CNTs available from Carbon Solution Inc., SWCNTs available from Aldrich, or MWCNTs available from Cheap Tubes.

In an embodiment, the CNTs may be added as a percentage of aniline added. In an embodiment, the amount of CNTs added, as a percentage of aniline added, may be between about 0.1%, and 25%. In another embodiment, the amount of CNTs added, as a percentage of aniline added, may be between about 2%, and 20%. In yet another embodiment, the amount of CNTs added, as a percentage of aniline added, may be 0.35%, 5% or 15%. In a particular embodiment, the amount of CNTs added, as a percentage of aniline added, may be about 2%.

The compoites of the invention may be made through any process known in the art. In some embodiments, the synthesis may be chemical, in other embodiments, the synthesis may be electrochemical. In some embodiments, CNTs may be incorporated into the PANI through emulsion polymerization techniques. For example, in an embodiment, CNTs, DNNSA, and aniline could all be added to a vial and stirred to form an emulsion.

A solution of ammonium peroxydisulfate (APDS) could then be added to the vial, dropwise, as an oxidant for the process. Via oxidative polymerization, the CNT/PANI/DNNSA synthesis will occur. In this embodiment, an organic layer having a low density may be added to the solution. The organic layer may be xylene. The organic and aqueous phases may then be separated, retaining the organic phase. The CNT/PANI/DNNSA composite may then be placed in a rotary evaporator to remove the solvents from the sample. In an embodiment, the CNT/PANI/DNNSA composite may be sonicated to break apart agglomerated CNTs before forming into a film.

In another embodiment, the inventive composites could be synthesized using a direct blending technique. In this embodiment, CNTs and xylene could be intermixed, optionally sonicated, and then added to a conductive polymer product, such as EMPAC™ 1003 or EMPAC™ 1007. The product could then be stirred overnight to form the composite.

In an embodiment, the above processes may incorporate surfactants and/or solvents to break up agglomerated CNTs and suspend them while being mixed. The surfactants and/or solvents may be any known in the art. In a particular embodiment, the surfactant or solvent may be selected from the group Bayowet FT-219, Disperbyk-191, Baytron M (3,4-ethylenedioxythiophene), Dynol 604, Dodecylbenzenesulfonic Acid Sodium Salt (DBSA), Dimethylformamide (DMF), and Tetrahydrofuran (THF). The solvents and/or surfactants may be added to the CNTs to disperse them prior to adding them to the aniline solution, to the aniline solution prior to addition of the CNTs, or at the same time as the CNTs are added to the aniline solution.

In yet another embodiment, functionalized CNTs may be used in the synthesis of the composites. The functionalized CNTs may comprise OH functionalized CNTs or COOH functionalized CNTs. In some embodiments, functionalization of SWCNTs was found to increase the conductivity up to about 50 S/cm.

In some embodiments, the CNTs may be hydrophobic or hydrophilic. In a particular embodiment, the CNTs are hydrophilic.

In an embodiment, the composite may be prepared via solution formulation (blending) of EMPAC™ 1003 or EMPAC™ 1007, commercially available from Crosslink Energy Materials, and CNT in xylene/butyl cellosolve (BCS).

In an embodiment, the CNTs may be dispersed uniformly in the preparation. In another embodiment, the CNTs may be substantially dispersed uniformly in the preparation.

In an embodiment, the solution prepared by one or more of the methods herein is treated with a secondary dopant. Secondary doping of conductive polymers can be performed to overcome the limitations of primary-doped conductive polymers in achieving metal-like conductivity. In some embodiments, the secondary doping may be conducted by washing the polymer film to remove excess, unbound primary dopant from the polymer, inducing transformation of the coil-like conformation of polymers in the film to an expanded-chain formation, and formation of close-packing of polymer chains upon heat treatment, which promotes π-π stacking of phenyl rings in the polymer film and the dopant and hydrogen bonding of hydroxyl groups in dopants with amine and imine sites in PANI.

In some embodiments, SDP is the secondary dopant and may be added to the solution prior to preparation of a film. In other embodiments, the films are prepared and then a secondary dopant is used. In this embodiment, the films may be dipped in a PTSA/PTSAM in BCS solution followed by a xylene wash and heat treatment.

In an embodiment, the conductive polymeric films may be prepared using any method known in the art. In a particular embodiment, the polymeric films are formed by spin coating the final solution onto glass slides.

In some embodiments, the invention comprises a supercapacitor having electrodes utilizing the polymeric films herein.

The supercapacitor may comprise a first substrate comprising a first and second surface; a first electrode having a first and second side, wherein the first side is adjacent the second surface of the first substrate, and comprising an intrinsically conductive polymer comprising polyaniline, carbon nanotubes, and DNNSA; an electrolyte adjacent the second side of the first electrode; a second electrode having a first side and a second side, wherein the first side is adjacent the second side of the first electrode and separated from the first electrode by the electrolyte, and comprising an intrinsically conductive polymer comprising polyaniline, carbon nanotubes, and DNNSA; and a second substrate having a first surface and a second surface, wherein the first surface is adjacent the second side of the second electrode.

Exemplary electrolytes contemplated as useful in accordance with the present invention are one more of EMI-IM, lithium-bis(trifluoromethanesulfonyl)imide (Li-IM), silicotungstic acid, and combinations thereof. In a particular embodiment, the supporting electrolyte for the composite film in the supercapacitor is acidic in nature. The supporting electrolyte may be PTSA in EMI-IM/PC.

In some embodiments, it may be desirable to include one or more optional separators between the electrolyte and the electrodes of the supercapacitor. Optionally, the supercapacitor may also include a spring and/or additional spacers. Exemplary materials contemplated as useful spacers, where utilized, are polytetrafluoroethylene (PTFE), polypropylene, polycarbonate, polyvinyl chloride, other electrically insulating polymers, ceramics, and combinations thereof.

In some embodiments, the ICP films may be pelletized prior to their inclusion as electrodes. In other embodiments, the ICP films may be in the form of a paste.

The present ICP films may be utilized in any of Type I, II, III, and IV supercapacitors. Moreover, it may be desirable, in some embodiments, to utilize different ICP films in the same supercapacitor.

In particular embodiments of the invention, the supercapacitors of the invention may be coin cell supercapacitors. In an embodiment, the coin cell may be layered as follows: a layer of stainless steel (SS) foil is set forth as a first layer, a second layer of CNTs is coated onto the SS foil layer, and a third layer of conductive polymer is coated onto the CNT layer. In an embodiment, the SS foil layer may be prepared in a disk shape and may have a radius of about 1 to 20 nm. In another embodiment, the SS foil layer may have a radius of about 1 to 20 nm. The SS foil may have a thickness between about 100 and 1000 nm. In an embodiment, the thickness of the SS foil may be about 450 nm. The sheet resistance of the SS layer may be about 45 Ohm/sq. In an embodiment, the conductive polymer layer may be a PANI polymer. In a particular embodiment, the conductive polymer layer may be EMPAC™ 1003 or EMPAC™ 1007. In a particular embodiment, the polymer layer may be spin coated onto the CNT layer. In certain embodiments, the electrolyte for the coin cell may be a mixture of 0.5M Li-IM in EMI-IM:PC (1:1 ratio).

In some embodiments, the inventive composites may be coated onto porous carbon paper. In this embodiment, the composites may be coated via electropolymerization or chemical polymerization. In a particular embodiment, chemical polymerization is utilized. If electropolymerization is utilized, the composite may be coated via potential sweep cyclic voltammetric methods or potential pulse polymerization methods. In some coating embodiments, the capacitance of a composite coated on carbon paper is significantly higher than that of pure carbon paper. In a particular embodiment, the capacitance is at least 10 times higher than that of pure carbon paper.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples.

### EXAMPLE 1

Materials

CNTs:

SWCNTs from Aldrich (Catalog Number 589705). 10-40% SWCNT, the remainder being carbon-coated metal nanoparticles and amorphous carbon nanopowder;

Multi Wall Carbon Nanotubes (MWCNT) from Cheap Tubes; maximum 95% MWCNT:

MWCNTI with a diameter of 8 to 10 nm and a length of 50 μm; and

MWCNT2 with a diameter of 20 to 30 nm and a length of 50 μm;

Methods

In this method, PANI was synthesized with various amounts of CNT present during the reaction.

Equipment:
A) 20 ml vial w/cap
B) Stir plate
C) Transfer pipits
D) Ice Water in shallow container
E) Teflon coated magnetic stir bar

Recipe: (Reduced to 1% of standard run)

| A) DI water | 8.33 | g |
|---|---|---|
| B) DNNSA | 4.38 | g |
| C) Aniline | 0.369 | g |
| D) CNT added as a percentage of aniline | | |
| E) DI water | 2.47 | g |
| F) APDS | 112.2 | g |

Synthesis Procedure:
1) Add CNT to vial.
2) Add DNNSA to vial. Stir.
3) Add aniline to vial. Stir.
4) Add 8.33 g of water. Stir.
5) Cool Vial to between 1° and 3° C.
6) Dissolve APDS in 2.47 g of water.
7) Add APDS/water mixture dropwise into vial. Stir.
8) Stir overnight. Add 15 g xylene in the morning. Mix well.
9) Charge to separation funnel and let separate, PANI/CNT on top, water on bottom. Drain off water.
10) Add 5 g of 0.01 M H₂SO₄. Mix well, let separate, drain bottom phase.
11) Add 5 g of DI water, mix, drain bottom phase.
12) Rotovap PANI/CNT/xylene to required % solids.

The chemical reaction is shown below.

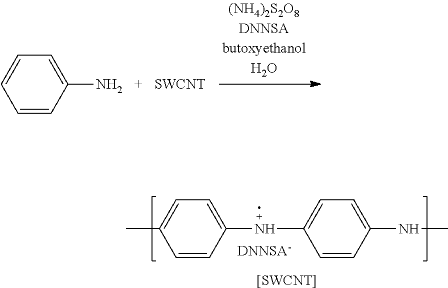

Films were made by spin coating PANI with and without CNT onto glass slides as follows:
1) Place glass slide on vacuum spindle of the spin coating equipment.
2) Add approximately 6 drops to slide.
3) Spin at approximately 1700 RPM for 30 seconds.
4) Dry film at 140° C. for 15 minutes.
5) Screen print silver bars onto the film, which are one inch apart and one inch long.
6) Dry again for 5 minutes at 140° C.
7) The sample is then dipped in methanol for approximately 10 seconds.

This process defines a conducting surface of one square inch. Ohms/square are measured from this surface. Calculating Siemens/cm (S/cm) utilized measuring film thicknesses with a Veeco Dektak profilometer in the KÅ range. By converting KÅ to cm and solving the following equation,

S/cm=1/(ohms/square×thickness in cm)

conductivity can be measured.

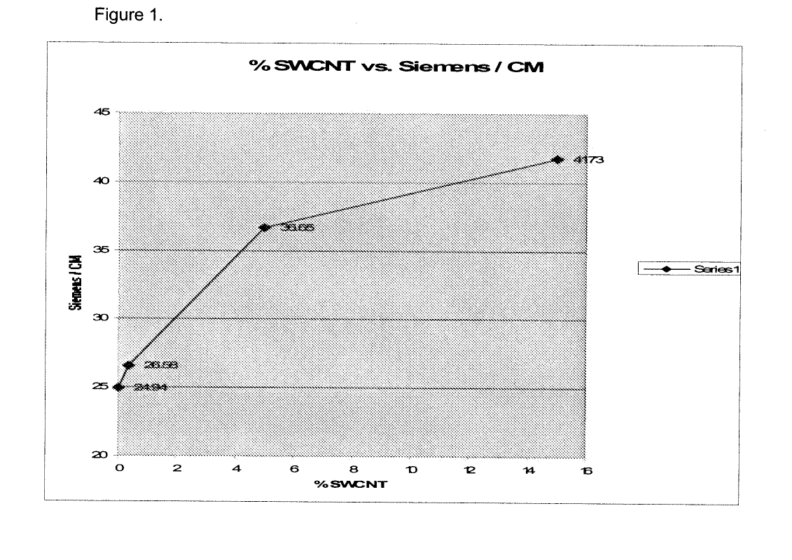

PANI was synthesized with CNTs at different loadings of 0.35%, 5% and 15%. These formulations were then cast as films and treated with methanol. The average conductivities are plotted in FIG. 1.

The conductivity of the films containing SWCNTs does not increase linearly with increasing concentration. It was also noted that with increasing concentration of SWCNTs there was more visible agglomeration of the CNTs (small rough black spots in the film).

To determine if the agglomerated CNTs contributed to the conductivity of the films, the solution of PANI/SWCNTs were put through a 5 micron syringe filter to remove the large particles. This filtered material was then cast as a film and the conductivity checked. The resulting films were essentially the same. This illustrates that PANI/SWCNTs solutions can be filtered to make a smooth film and the agglomerated SWCNTs do not contribute significantly to the conductivity of the films.

The synthesized PANI with 15% SWCNTs, when cast as a film, had a conductivity of about 41 S/cm. The same solution was then sonicated for about fifteen minutes at 40% power setting to break apart agglomerated SWCNTs. A film was then cast from this sonicated solution. The resultant film was observed to have a conductivity of 38 S/cm. PANI was also synthesized with a 2.35% loading of MWCNTs. The films that were made with this combination had a mean conductivity of 37.2 S/cm (±2). The conductivity of the 2.35% MWCNT material approaches that of a higher loading of the SWCNTs (5%). This might be explained by the purity of the CNTs used: the MWCNTs utilized were of a much higher purity than the SWCNTs.

MWCNT1 was mixed at a 1.5%, by weight to aniline loading into a PANI solution and stirred well. The resulting solution was spin coated and treated with methanol, yielding a conductivity of 23.1 S/cm. Increasing the concentration of MWCNT1 to 20%, by weight to aniline, in the PANI solution yielded films with conductivities of about 37 S/cm. While the lower loading of MWCNTs appears to reduce the conductivity, the 20% loading raises the conductivity significantly above the control sample conductivity of 25 S/cm.

A 15% loading of the larger diameter MWCNT2 mixed with PANI produced a film that had a conductivity of 38.7 S/cm. This is comparable to the 20% MWCNT1 result though it may not be significant assuming that the MWCNTs follow the same non-linear trend of the SWCNTs that were added in the synthesis of PANI as shown in FIG. 1.

Another portion of the 15% MWCNT2/PANI solution was sonicated for 15 minutes at 40% power to break up aggregated CNTs. The film that was cast from this solution had a conductivity of 43.8 S/cm. This shows a significant improvement in the conductivity of the film formed as compared to the unsonicated material. Thus breaking apart of the aggregated CNTs improves the conductivity of the material.

### EXAMPLE 2

In this example, the methods of Example 1 were carried out, but to allow for more interactions between the PANI through hydrogen bonds as well as van der Waals interactions, commercially available functionalized CNTs were evaluated.

Three samples of Multi Wall Carbon Nanotubes (MWCNTs) were evaluated:
1. Non-Functionalized
2. OH Functionalized
3. COOH Functionalized

The OH functionalized MWCNT had a diameter of 20 to 30 nm and a length of 50 μm and the COON functionalized MWCNT had a diameter of 20 to 30 nm and a length of 50 μm. Both were obtained from Cheap Tubes.

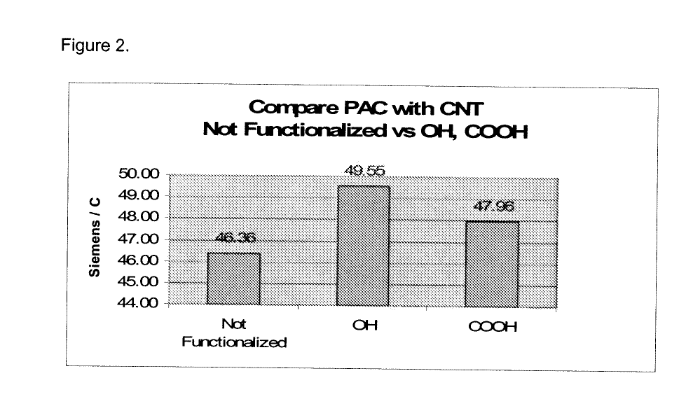

The nanotubes were separately mixed into PANI at 2% w/w MWCNT. The samples were spin coated and conductivity tests were performed. The results are plotted in FIG. 2. There were significant conductivity differences between the three samples, with the hydroxylated nanotubes outperforming the carboxylated and non-functionalized tubes.

Simple mixing of the functionalized MWCNTs, either —OH or —COOH functional groups, produced films with relatively good conductivities reaching approximately 50 S/cm at only a 2% loading.

### EXAMPLE 3

Materials

Sulfuric acid, tetrabutylammonium perchlorate (TBAP), acetonitrile, propylene carbonate, lithium perchlorate (LiClO₄), xylene, and BCS (each available from Sigma-Aldrich).

CNTs: (1) Brewer Science, Inc.: CNTRENE™ C100 (conc. 50 ppm in water, mostly single- and double-walled CNT with electrical resistivity of 100-200 ohms); (2) Carbon Solution Inc.: P5-SWNT (octyldecylamine functionalized single wall carbon nanotubes, organic-solvent soluble).

Methods

The methods comprise (A) synthesis and characterization of processible PANI/CNT composites via emulsion polymerization and (B) solution formulation (direct blending).

Method A:

Emulsion polymerization of aniline in situ dopants and CNT

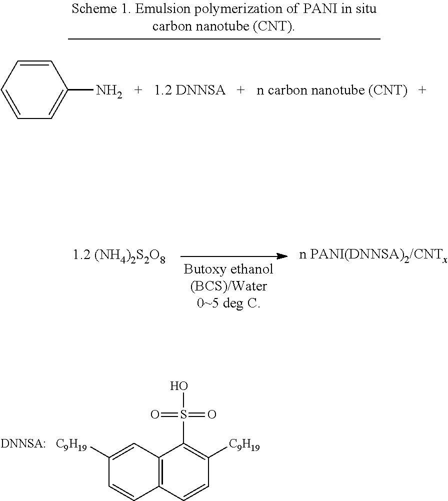

In this example, 0.37 g (3.97 mmol) of aniline and 7.5 g of CNT (0.375 mg) solution (50 ppm in water from Brewer Science) were placed into a 20 mL vial with a magnetic spin bar. Then, 4.32 g (Nacure® 1051, 4.76 mmol, 1.2 eq) of DNNSA was added to the vial. The mixture was stirred to give an emulsion and the flask was put on an ice bath to chill the mixture to between about 0 and 5° C. Ammonium peroxydisulfate (1.12 g, 4.9 mmol, 1.2 eq) in 2.5 g of DI water was added to the mixture over the course of about 5 minutes and the mixture was then stirred. After 3 hours, the mixture became phase-segregated to give a dark green tar as the top layer and a colorless solution as the bottom layer. 20 g of xylene was added to the mixture and the mixture was poured into separation funnel. The aqueous layer was removed and 5 or 6 mL of 0.01 M H₂SO₄ was added to remove ammonium byproducts. The organic layer was transferred to a 200 mL flask and the volume was reduced in a Rotoevaporator. The final concentration of PANI/CNT (formula A-F) obtained was between 20% and 25% w/w in xylene/BCS (Table 1).

TABLE 1
Emulsion polymerization of PANI in situ CNT

| | | | | Film |
|---|---|---|---|---|
| | | | Solution conc. | processibility |
| PANI- | | | (solid % w/w | by spin |
| DNNSA/ | Synthetic | CNT:PANI* | in Xylene/ | coating on |
| CNT | Technique | (w/w ratio) | BCS) | glass) |
| Formula A | Emulsion | 0.10% | 20% | Yes |
| | polymerization | | | |
| Formula B | Emulsion | 0.5% | 23% | Yes |
| | polymerization | | | |
| Formula C | Emulsion | 1.6% | 25% | Yes |
| | polymerization | | | |
| Formula D | Emulsion | 2.7% | 25% | Yes |
| | polymerization | | | |
| Formula E | Emulsion | 5.7% | 25% | Yes |
| | polymerization | | | |
| Formula F | Emulsion | 8.1% | 25% | Yes |
| | polymerization | | | |

Emulsion polymerization temp. 0-5° C.
Mole ratio of dopant/aniline = 1.2/1; oxidant/aniline = 1.2/1
*calculated assuming 100% aniline monomer conversion to PANI Formulas B through F include CNT obtained from Carbon Solutions, Inc. [functionalized SWCNT with octadecylamine (ODA)]. Formula A includes CNT solution (50 ppm in water) obtained from Brewer Science Inc.

Method B:

Solution formulation (direct blending) of EMPAC™ 1003 with CNT in xylene/BCS (Scheme 2)

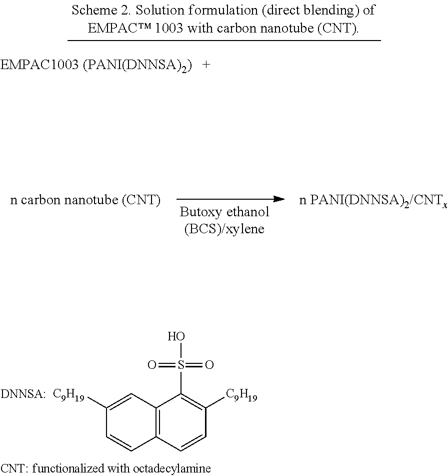

0.13 mg of CNT was placed in 20 mL vial and 2 g of xylene was added to the vial. The CNT/xylene mixture was sonicated for 10 min. The CNT/xylene solution was added to 10 g of EMPAC™ 1003 (15% w/w in xylene/BCS). The EMPAC™ 1003/CNT solution (formula 1-5) was stirred overnight at room temperature. The resulting concentration of the formula was 12.5% w/w in xylene/BCS (Table 2).

TABLE 2
Solution formulation of EMPAC ™ 1003 with CNT

| | | | Solution | Film |
|---|---|---|---|---|
| | | | conc. (solid | process- |
| | | | % w/w in | ibility (by |
| EMPAC ™ | | CNT:PANI* | xylene/ | spin coating |
| 1003/CNT | CNT vendor | (w/w ratio) | BCS) | on glass) |
| Formula 1 | Carbon | 0.6% | 13% | Yes |
| | Solutions Inc. | | | |
| | (P5-SWNT) | | | |
| Formula 2 | Carbon | 3.0% | 13% | Yes |
| | Solutions Inc. | | | |
| | (P5-SWNT) | | | |
| Formula 3 | Carbon | 5.0% | 12% | Yes |
| | Solutions Inc. | | | |
| | (P5-SWNT) | | | |
| Formula 4 | Carbon | 10.0% | 9% | Yes |
| | Solutions Inc. | | | |
| | (P5-SWNT) | | | |
| Formula 5 | Nanodynamics | 2.0% | 11% | Yes |

Solution formulation temp. RT
*calculated assuming 100% aniline monomer conversion to PANI CNT obtained from Carbon solutions Inc. [functionalized SWCNT with octadecylamine (ODA)]

Processible secondary doped PANI/CNT composites via solution formulation (blending) with SDP. 5.00 g of 15% solid w/w Formula A (Table 1) in xylene/BCS was placed in 20 mL vial. Then 0.083 g SDP, as a secondary dopant, was dissolved in xylene/BCS (3.33 g). The SDP solution was slowly added into Formula A and the mixture was stirred overnight at room temperature. The final formula concentration was 10% solids w/w in xylene/BCS.

Secondary-doping procedure for PANI/CNT composites. First, PANI/CNT films were prepared by spin coating method followed by heat-treatment at 150° C. for 30 minutes. Thymol vapor-cleaning was carried out by exposing the films to thymol vapors at 150° C. for 30 minutes. PTSA/PTSAM treatment was carried out by dipping the PANI/CNT films in 5% PTSA/0.5% PTSAM in BCS solution for 30 seconds followed by xylene wash and heat treatment at 150° C. for 30 minutes.

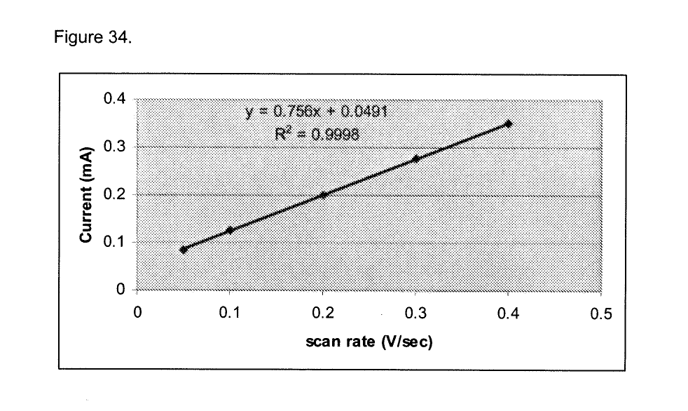

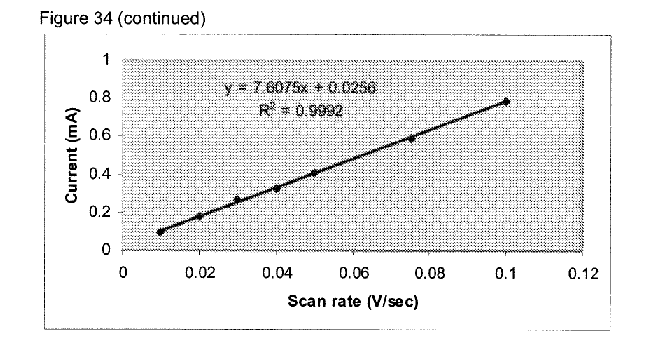

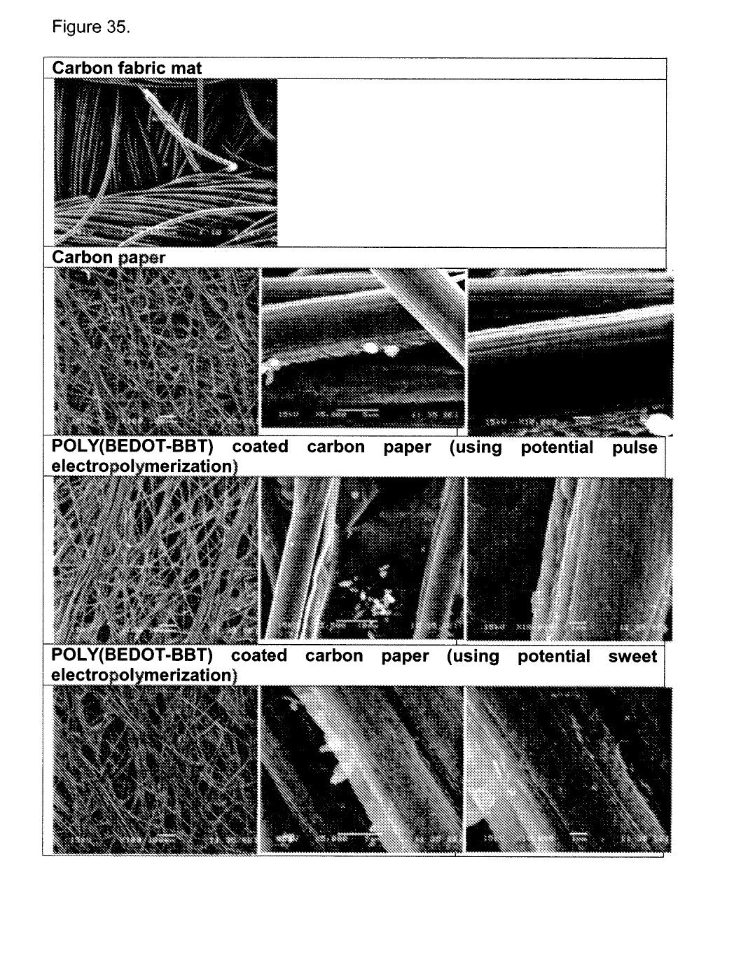

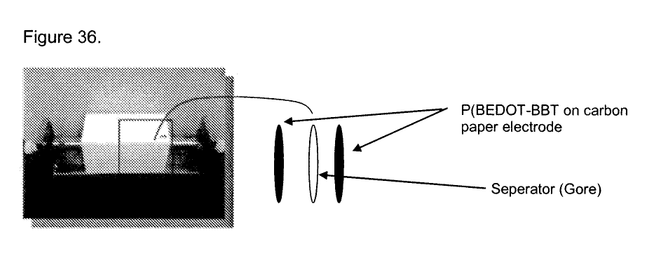

Electro-characterization of PANI/CNT composites. PANI/CNT composites were coated via a spin coating method at 2000 rpm for 30 seconds from a xylene/BCS solvent base onto stainless steel disks (0.75 inch diameter), which were pre-coated with a gold interfacial layer. CV scans of PANI/CNT composites were collected using both PARSTAT® 2273, available from Princeton Applied Research, and CH660C, available from CH Instruments, using a three-electrode H-cell configuration (FIG. 34). The counter and reference electrodes used were Pt gauze or wire and standard calomel electrode (SCE) in case of aqueous electrolytes (1M H₂SO₄). The reference electrode used was Ag/AgNO₃ in non-aqueous electrolytes such as 0.2 M Tetra-n-butylammonium perchlorate (TBAP)/ACN, 0.1 M TBAP/PC and 0.1M LiClO₄/PC.

Preparation of PANI/CNT composite thin films. A spin coating method was used for preparing the thin film on a suitable substrate. The formulas (15% w/w) were added to the center of the substrate and spin coated at 1000 rpm or 1500 rpm for 30 seconds. After the film was coated on the glass, it was dried in air for 10 minutes and placed in an oven at 150° C. for 30 minutes.

Film Characterization: The conductivity of the film was calculated by the following equation 1:

Conductivity=W/(R×L×T) (1)

W: the width of the film, which is the distance between two parallel silver bars, L: the length of the film, which is the length of silver bar, T: the film thickness, which was measured by con-focal microscopy, profilometer or AFM, and R: the resistance of the film measured by the multimeter. In our case W equals to L, and the equation 1 can be simplified to the following:

Conductivity=1/R×T

Specific Capacitance (F/g) calculated by electrochemical behavior.

A) Cyclic voltammetry method. A psedocapacitive current is observed with increase in scan rate. The pseudocapacitance was calculated from the following equation: Ccv=(dl×dt)/(dV×m)
Pseudocapacitance is the slope of the current vs. scan rate curve. Ccv: capacitance (F) obtained from CV method m: the mass of active material

B) Chronopotentiametry (Galvanostatic charge-discharge)
Cg=I×Δt/ΔV×rn
Cg: specific capacitance (gavanostatic charge-discharge method)
I : applied current (A)
Δt: discharge time (sec.)
ΔV : applied voltage for charge-discharge (V)
M : polymer weight (g)

Instrumentation

UV-vis-NIR spectrophotometer: Shimadzu UV-3600.

Electrochemical characterization: CH Instruments CH 660C and Princeton Applied Research Advanced Electrochemical System PARSTAT® 2273.

Resistance measurement: Digital multimeter MASHTECH MS4226 and RS232 interface software.

Film thickness: con-focal microscope and digital micro gauge.

Arbin tester: coin cell charge/discharge experiment for supercapacitor or batteries.

Preparation of PANI/CNT composites. In one experimental variant, PANI/CNT composites were prepared via emulsion polymerization of aniline monomer in situ an aqueous solution of CNT, for use as electrodes in coin cells (Formula A-F shown in Table 1). In another variant, PANI/CNT composites were prepared by directly solution-blending EMPAC™ 1003 with CNT in an organic medium (Formula 1 through 5 shown in Table 2). Up to a w/w ratio of CNT:PANI of about 8%, the PANI/CNT formulas exhibited very good solution processibility.

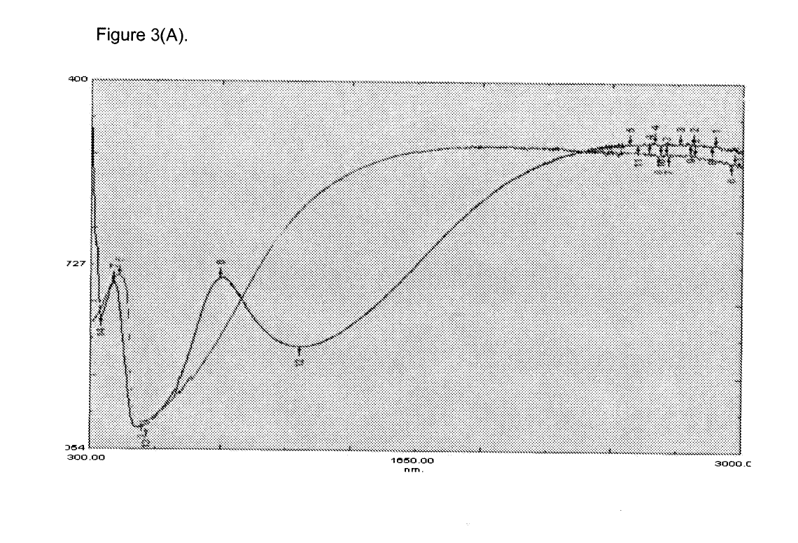

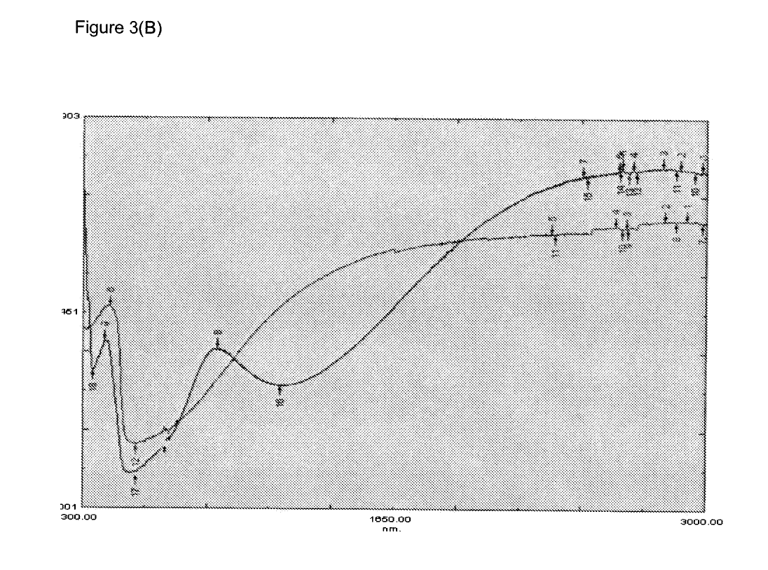

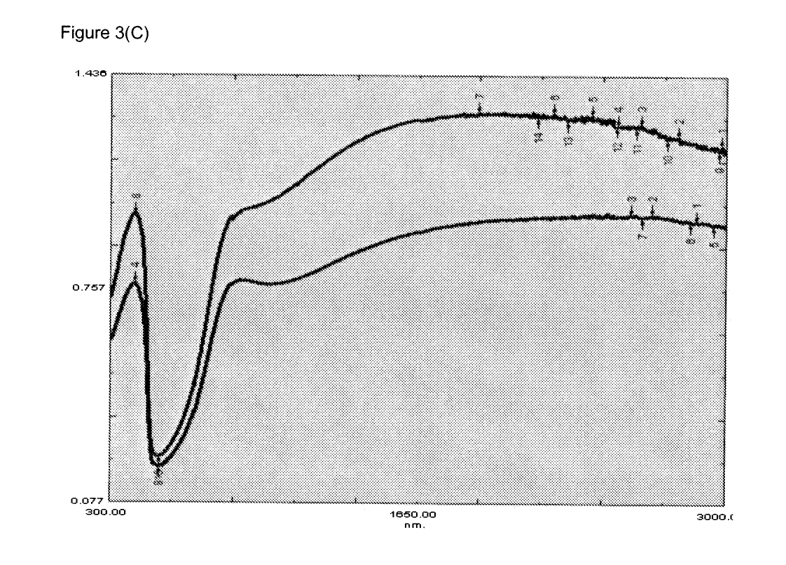

Optical properties of PANI/CNT composites. To study the optical properties of PANI/CNT composites, composite films were prepared by spin coating PANI/CNT solution on glass substrates (see FIG. 3). The addition of CNT to PANI did not alter the usual spectral characteristics of PANI. The polaron peak that was observed for PANI-DNNSA/CNT films disappears and a broad band covering the far-IR spectral region is instead observed for secondary-doped PANI/CNT films. This spectral behavior of PANI/CNT composites is quite similar to pristine PANI-DNNSA films.

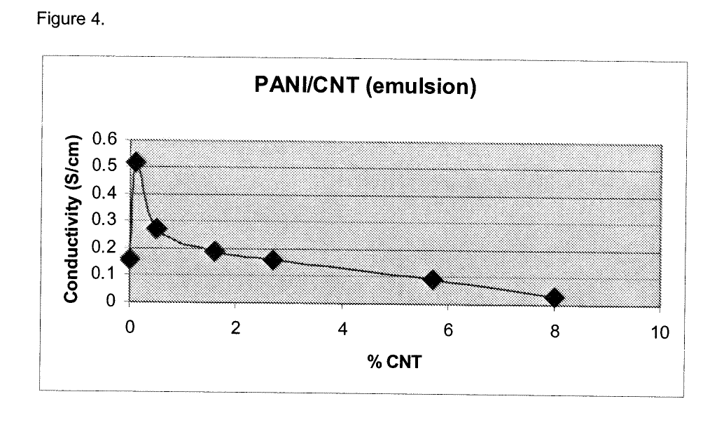

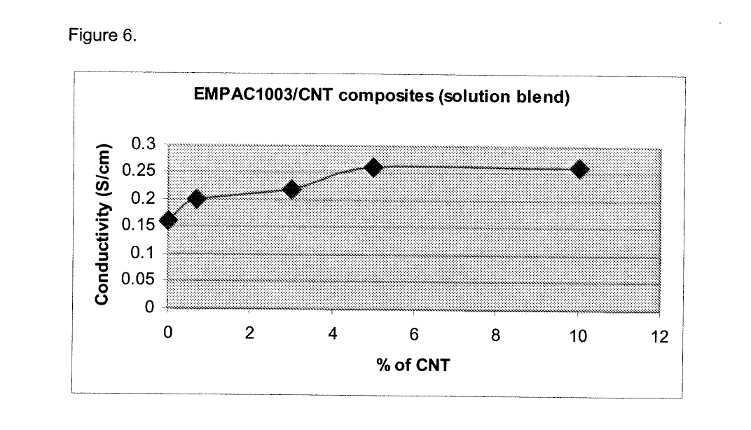

Electrical conductivity of PANI/CNT composites (two silver-probe measurement). Electrical conductivity of PANI/CNT composites having an approximate thickness of about 1 micron was measured using silver contacts in a two-probe configuration. Among the PANI/CNT composites prepared by the emulsion polymerization technique, Formula A (contains 0.1% CNT in PANI) exhibited the highest conductivity (ca. 0.52 S/cm) following the heat treatment (see FIG. 4). When the amounts of CNT were increased, the composite conductivity slightly decreased. On the other hand, for the PANI/CNT composites prepared by the solution blending technique, the formulas that contained high amounts of CNT in PANI exhibited the highest conductivity (ca. 0.26 S/cm) following the heat treatment (see FIG. 6).

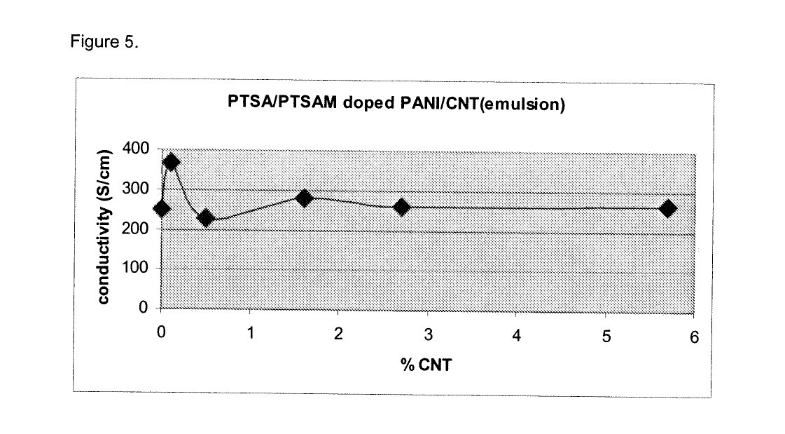

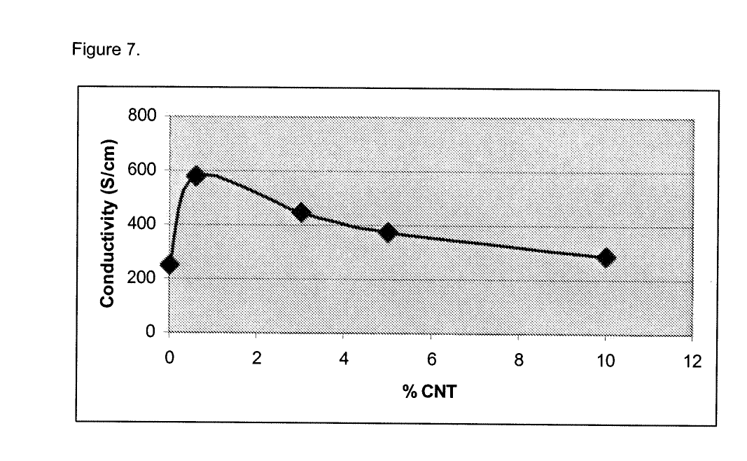

The electrical conductivity of the PANI/CNT composites prepared by the emulsion polymerization technique exhibited enhanced conductivity following the PTSA/PTSAM secondary-doping treatment in comparison with EMPAC™ 1003 (250 S/cm in 4-probes measurement) without CNT (see FIG. 5). Also, the PANI/CNT composites prepared by solution blending technique exhibit enhanced conductivity following the para-toluenesulfonic acid (PTSA)/para-toluenesulfonamide(PTSAM) secondary-doping treatment (see FIG. 7). The secondary doping was used as film dipped into dopant solution. This method gives the advantage of removing extra dopant. The film thickness decreased after dipping. Formulas 4 and 5 showed less electric conductivity than Formulas 1 and 2. These results were consistent with their optical results.

TABLE 3
Conductivity of PANI/CNT composites
from emulsion polymerization

| | | Resistance | Thickness | Conductivity |
|---|---|---|---|---|
| Sample | Conditions | (Ω) | (nm) | (S/cm) |
| EMPAC ™ | Heat | | | 0.16 |
| 1003 | PTSA/PTSAM | | | 250 |
| Formula A | Heat | 17,640 | 1,091 | 0.52 |
| (0.1% CNT) | Xylene | 3,066 | 369 | 8.8 |
| | PTSA/PTSAM | 77.6 Ω | 382 | 337 |
| Formula B | Heat | 41,200 | 890 | 0.27 |
| (0.5% CNT) | PTSA/PTSAM | 146 | 302 | 227 |
| Formula C | Heat | 62,000 | 868 | 0.19 |
| (1.6% CNT) | PTSA/PTSAM | 160 | 212 | 260 |
| Formula D | Heat | 75,900 | 834 | 0.16 |
| (2.7% CNT) | PTSA/PTSAM | 119 | 212 | 260 |
| Formula E | Heat | 121,000 | 941 | 0.09 |
| (5.7% CNT) | PTSA/PTSAM | 147.4 | 256 | 265 |
| Formula F | Heat | 473,000 | 670 | 0.03 |
| (8.1% CNT) | PTSA/PTSAM | | | |

Heat treated EMPAC ™ 1003: 0.16 S/cm (four bars)
Thickness measurement used con-focal microscopy
Resistance was measured by two silver bars (0.8 cm × 0.8 cm)
Formula F failed to make secondary doped PANI/CNT due to film delaminating

TABLE 4
Conductivity of PANI/CNT composites from solution formulation
with EMPAC ™ 1003 and CNT in xylene/BCS

| | | Resistance | Thickness | Conductivity |
|---|---|---|---|---|
| Sample | Conditions | (Ω) | (nm) | (S/cm) |
| EMPAC ™ | Heat | | | 0.16 |
| 1003 | PTSA/PTSAM | | | 250 |
| Formula 1 | Heat | 71,200 | 691 | 0.20 |
| (0.6% CNT) | PTSA/PTSAM | 94 | 183 | 581 |
| Formula 2 | Heat | 41,200 | 262 | 0.22 |
| (3% CNT) | PTSA/PTSAM | 136.2 | 164 | 448 |
| Formula 3 | Heat | 37,370 | 1,045 | 0.26 |
| (5% CNT) | PTSA/PTSAM | 72 | 366 | 379 |
| Formula 4 | Heat | 28,940 | 1,335 | 0.26 |
| (10% CNT) | PTSA/PTSAM | 100 | 348 | 287 |
| Formula 5 | Heat | 121,000 | 941 | 0.09 |
| (2% CNT) | PTSA/PTSAM | 147.4 | 256 | 265 |

All formulas used CNT from Carbon Solutions, Inc. except Formula 5 CNT which was from Nanodynamics Inc. The CNT from Carbon Solutions, Inc. was functionalized SWCNT with octadecylamine (ODA).

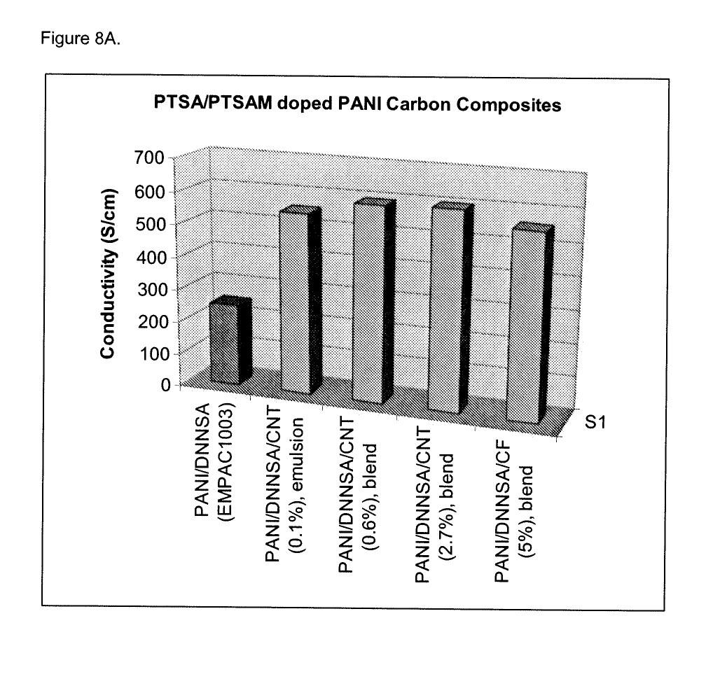

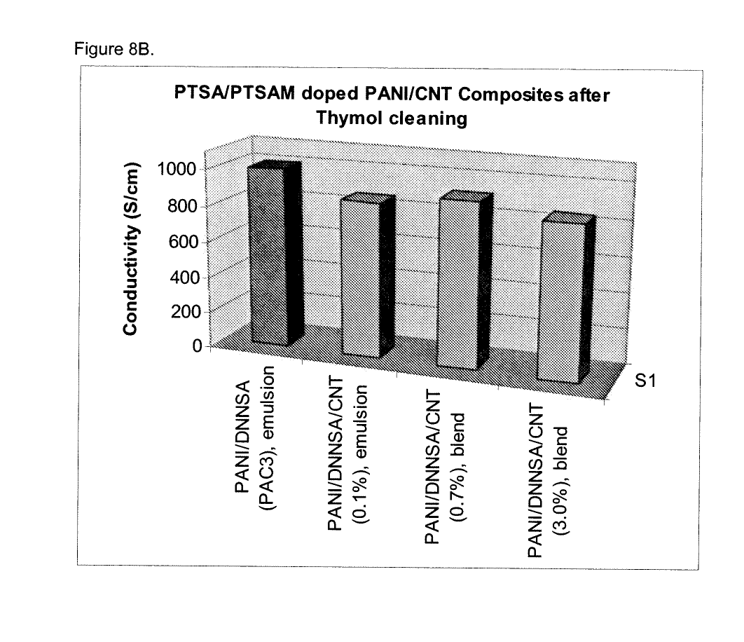

Electrical conductivity of PANI/CNT composites (Four gold-probe measurement). The electrical conductivity of PANI/CNT composites having a thickness in the proximity of about 1 micron was measured using gold contacts in a four-probe configuration. Among the PANI/CNT composites prepared by the emulsion polymerization technique, Formula A (contains 0.1% CNT in PANI) exhibited the highest conductivity (ca. 550 S/cm) following the PTSA/PTSAM secondary-doping treatment (see FIG. 8A). Among the PANI/CNT composites prepared by the solution blending technique, Formula 1 (contains 0.6% CNT in PANI) exhibited the highest conductivity (ca. 600 S/cm) following the PTSA/PTSAM secondary-doping treatment. Further, it was observed that inclusion of a thymol vapor-cleaning step before the PTSA/PTSAM secondary-doping step enhanced the conductivity by a factor of 2 (ca. 1000 S/cm) (see FIG. 8B).

TABLE 5
Conductivity of PANI/CNT composites (four gold probes)

| | | Resistance | Thickness | Conductivity |
|---|---|---|---|---|
| *Sample | Conditions** | (Ω) | (nm) | (S/cm) |
| EMPAC ™ | Heat | | | 0.16 |
| 1003 | PTSA/PTSAM | | | 250 |
| | Thymol_PTSA/ | | | 1,000 |
| | PTSAM | | | |
| Formula A | Heat | 9,320 | 1,065 | 0.25 |
| (emulsion) | Xylene | 559 | 570 | 7.9 |
| | PTSA/PTSAM | 13.9 | 326 | 552 |
| | Thymol_PTSA/ | 7.74 | 375 | 861 |
| | PTSAM | | | |
| Formula 1 | Heat | 26,400 | 673 | 0.14 |
| (blend) | Xylene | 1,040 | 254 | 9.5 |
| | PTSA/PTSAM | 25 | 168 | 595 |
| | Thymol PTSA/ | 15.9 | 172 | 914 |
| | PTSAM | | | |
| Formula 2 | Heat | 13,300 | 696 | 0.27 |
| (blend) | Xylene | 719 | 313 | 11.1 |
| | PTSA/PTSAM | 24.9 | 167 | 601 |
| | Thymol_PTSA/ | 17.7 | 167 | 846 |
| | PTSAM | | | |

4 gold-probe bars were thermally deposited onto films
*PANI/CNT films were prepared from a spin coating method
**heat: the films were treated by heat at 150 C. for 30 min.
Xylene: the films were washed with xylene to remove extra dopants PTSA/PTSAM: the films were dipped into 5% PTSA/0.5% PTSAM in BCS solution for 30 sec. then washed with xylene followed by heat treated at 150 C. for 30 min.
Thymol_PTSA/PTSAM: the films were cleaned with thymol vapors for 30 min followed by dipped into PTSA/PTSAM solution for 30 sec. and then heat treated at 150 C. for 30 min.

B) Synthesis and characterization of processible SDP doped PANI/CNT composites. EMPAC™ 1007 was utilized to make new EMPAC™ 1007/CNT composites.

Formulation of PANI/CNT and SDP. PANI/CNT composite solution in xylene/BCS was mixed with SDP solution in xylene/BCS. Then the mixture was stirred overnight at room temperature to give a homogenous solution. The resulting formula concentration was about 10% w/w in xylene/BCS (Table 6).

TABLE 6
Secondary doping of PANI/CNT composites obtained from emulsion polymerization

| | 15% w/w PANI/ | | SDP (based | Solution conc. | Film processibility |
|---|---|---|---|---|---|
| | CNT composites | % | on solid | (solid % w/w in | (by spin coating |
| | in xylene/BCS | CNT | portion) | xylene/BCS) | on glass) |
| ^{a}Formula | 5 g of | 0.10% | 10% | 10% | Yes |
| AS | Formula A | | | | |
| ^{b}Formula | 5 g of | 0.50% | 10% | 10% | Yes |
| BS | Formula B | | | | |

^{a}Formula AS means formula A mixed with SDP
^{b}Formula BS means formula B mixed with SDP

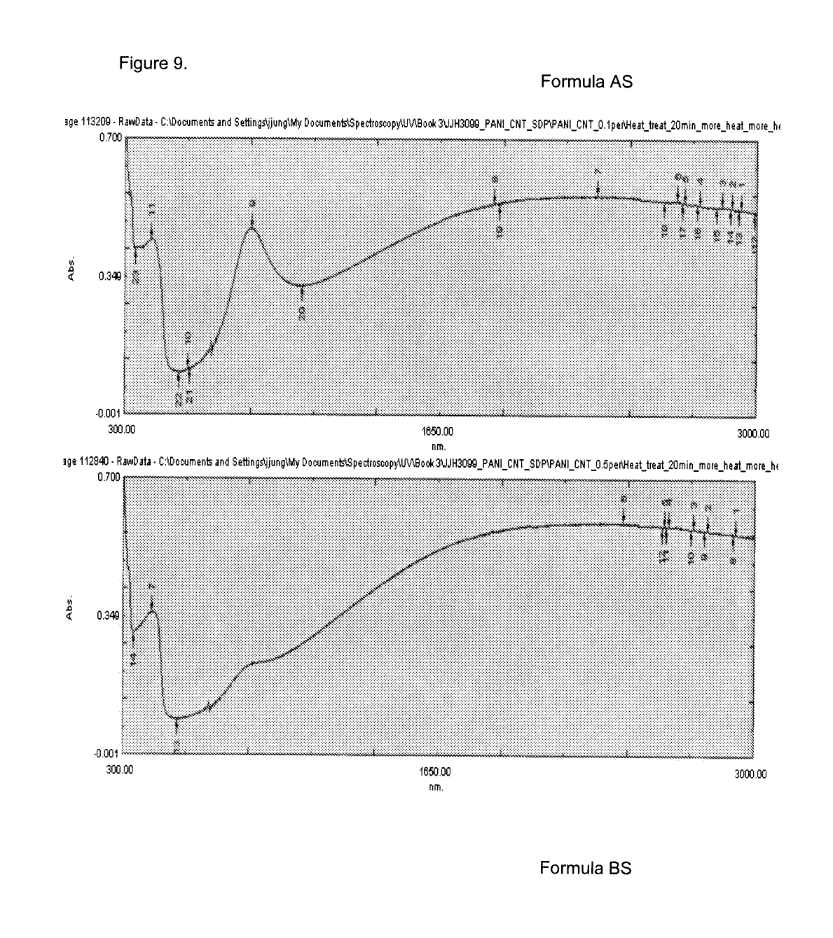

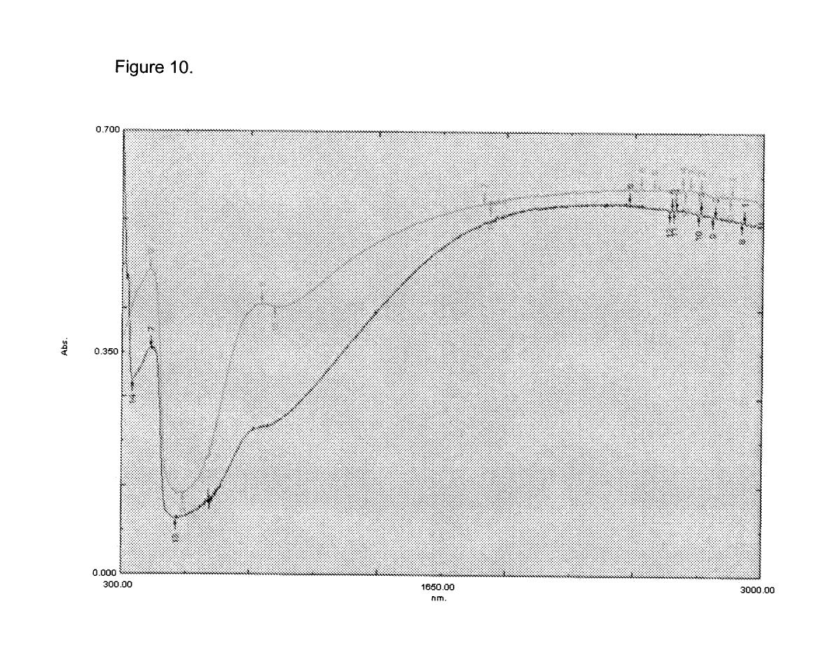

Optical properties of SDP doped PANI/CNT composites. To study optical property of PANI/CNT composites (FIG. 9), the composite films were prepared by spin coating on glass substrate. The PANI polaron peak did not disappear after heat treatment even though PTSA/PTSAM doped (FIG. 10). Nevertheless, total absorbance increased after an additional doping with PTSA/PTSAM. This increasing absorbance may be evidence of an electrical conductivity improvement.

Electric conductivity of processible SDP doped PANI/CNT composites (2 silver bars). The electrical conductivity of SDP doped PANI/CNT composite was measured using silver contacts in a two-probe configuration. Among PANI/CNT composites prepared by the emulsion polymerization technique, formulas that increased CNT amount increased electrical conductivity following the heat treatment (Table 7). When the composites were doped with PTSA/PTSAM via a dipping method, their conductivity was lower than without CNT.

TABLE 7
Conductivity of SDP doped PANI/CNT composites
that are obtained from emulsion polymerization

| | | Resistance | Thickness | Conductivity |
|---|---|---|---|---|
| Sample | Conditions | (Ω) | (nm) | (S/cm) |
| EMPAC ™ | Heat | | | 20 |
| 1007 | PTSA/PTSAM | | | 400 |
| Formula AS | Heat | 817 | 707 | 17 |
| | PTSA/PTSAM | 206 | 226 | 215 |
| Formula BS | Heat | 682 | 607 | 24 |
| | PTSA/PTSAM | 220 | 155 | 293 |

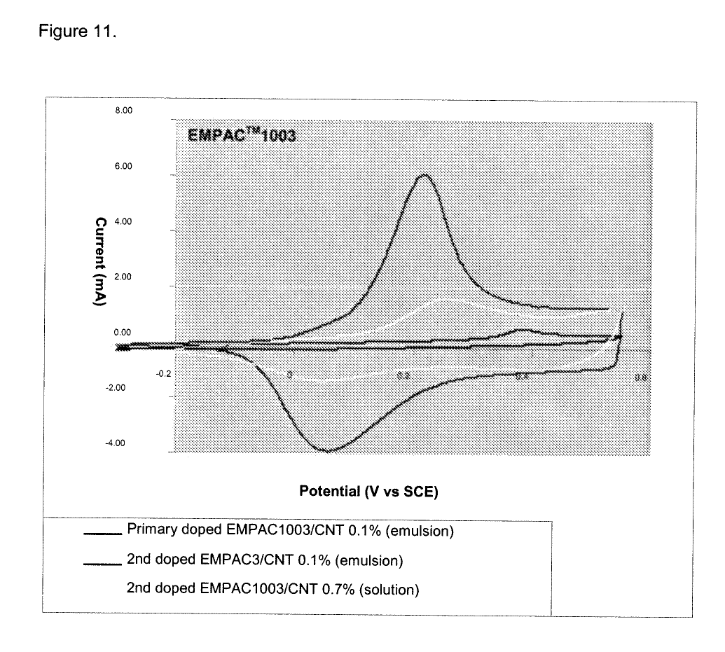

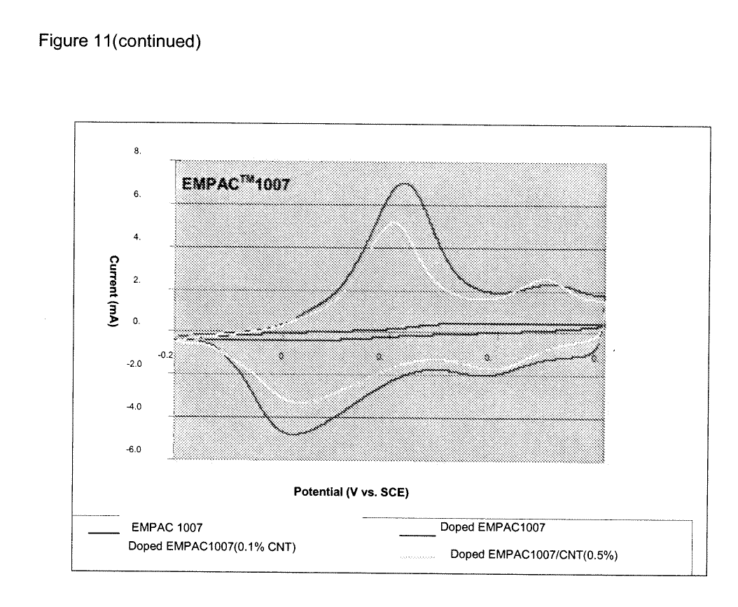

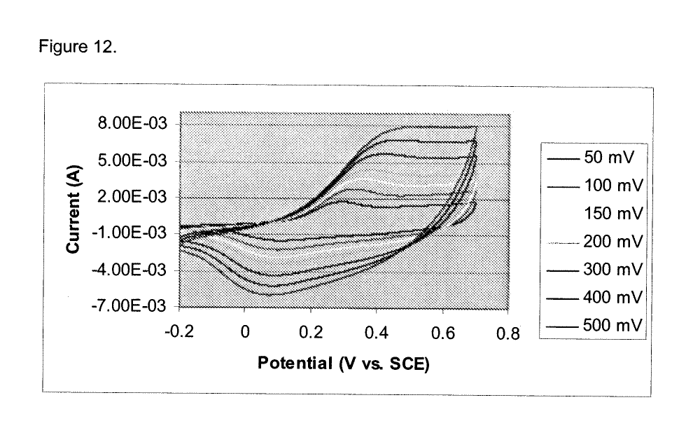

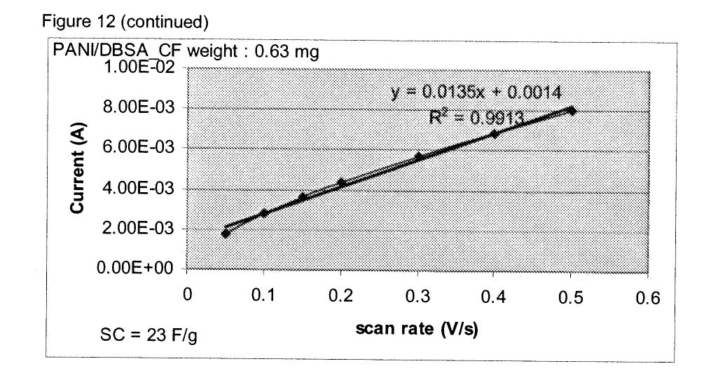

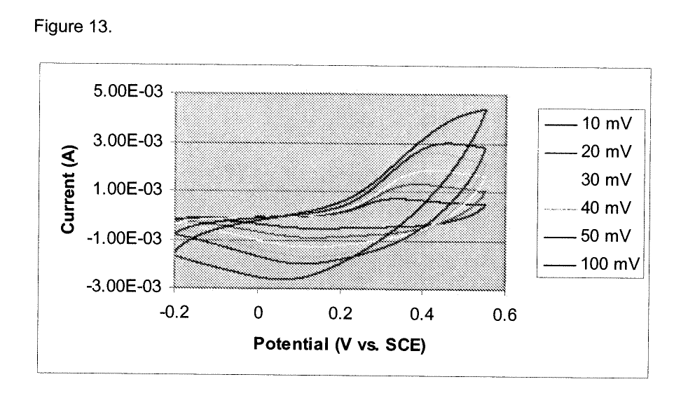

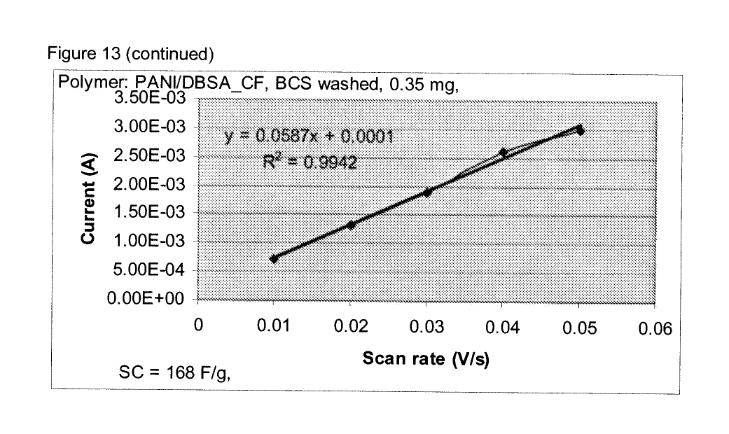

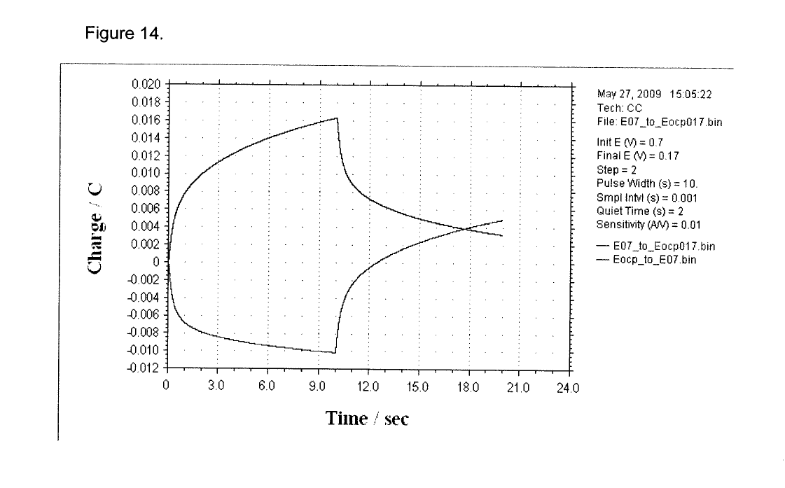

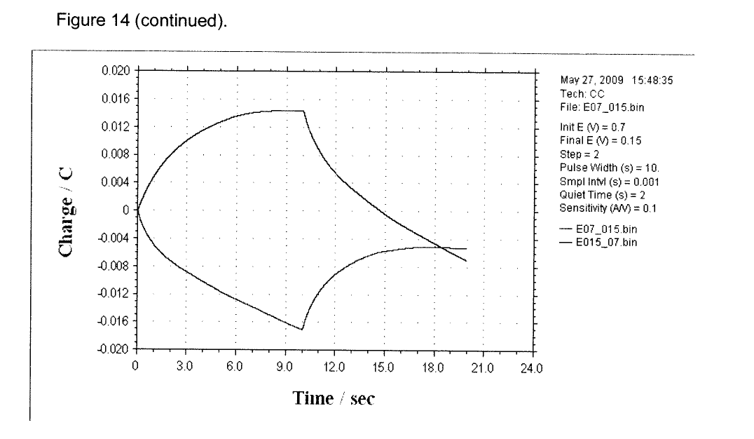

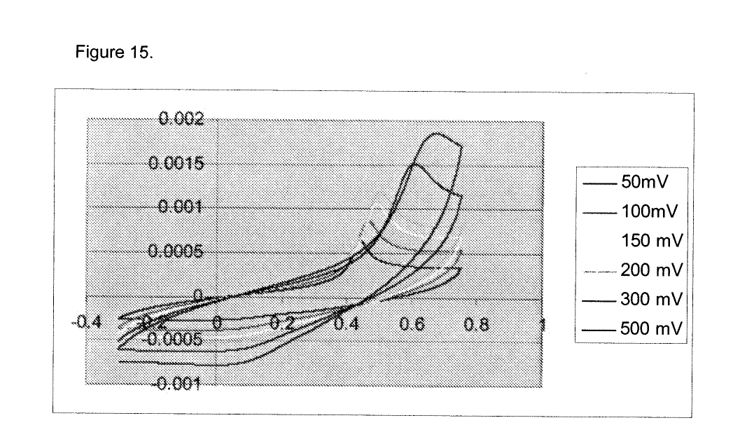

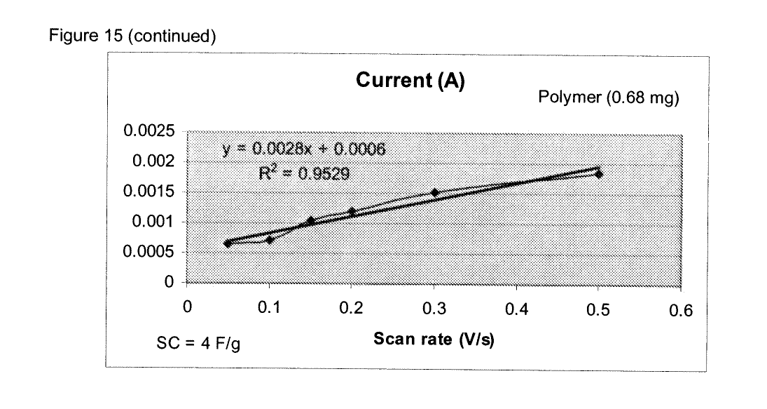

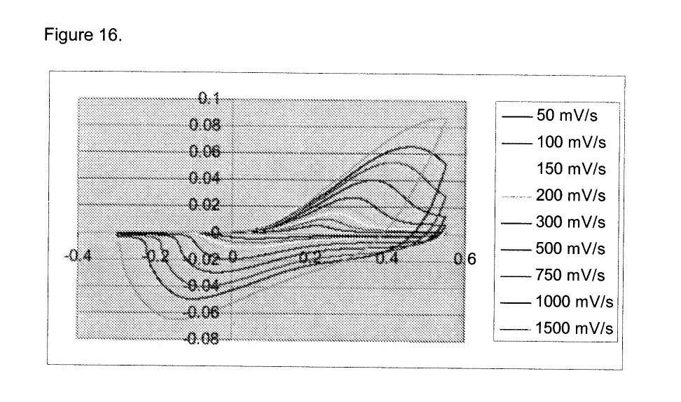

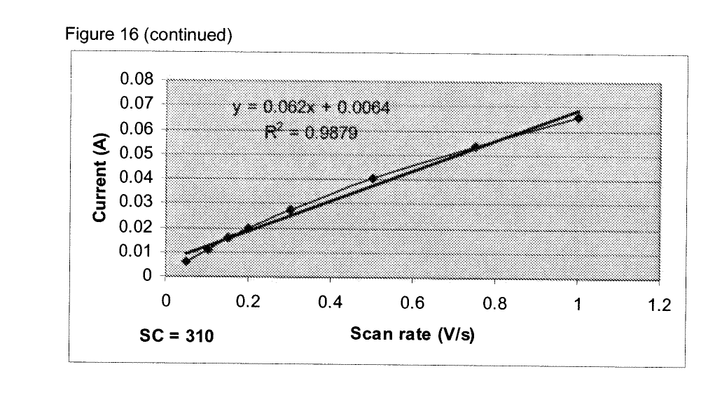

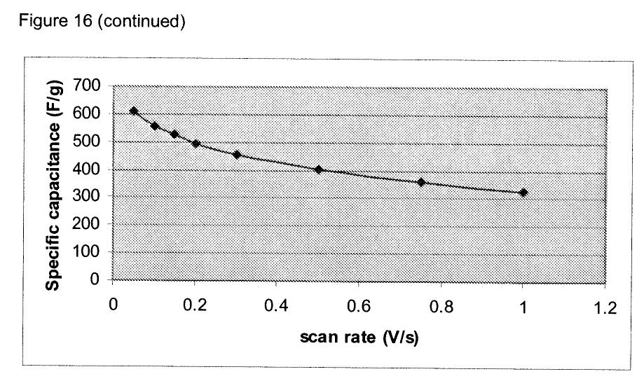

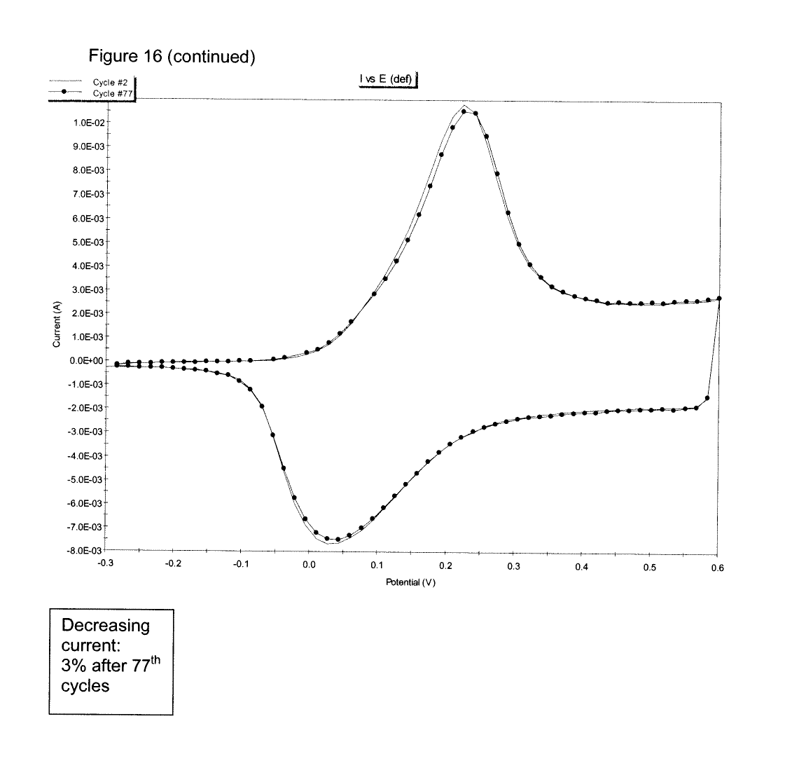

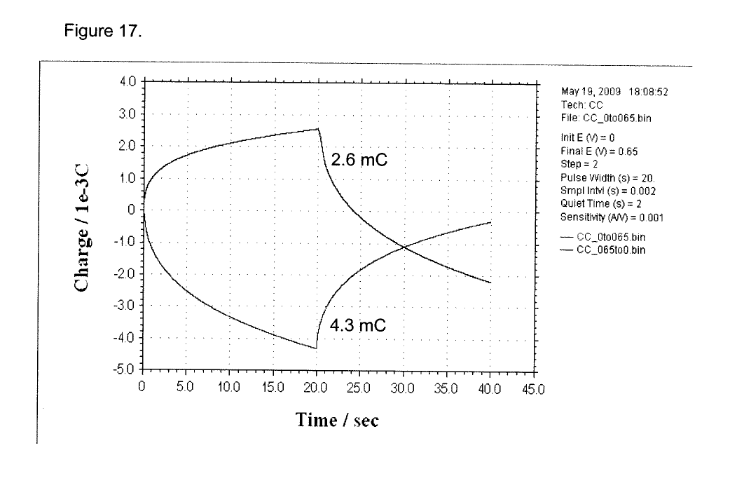

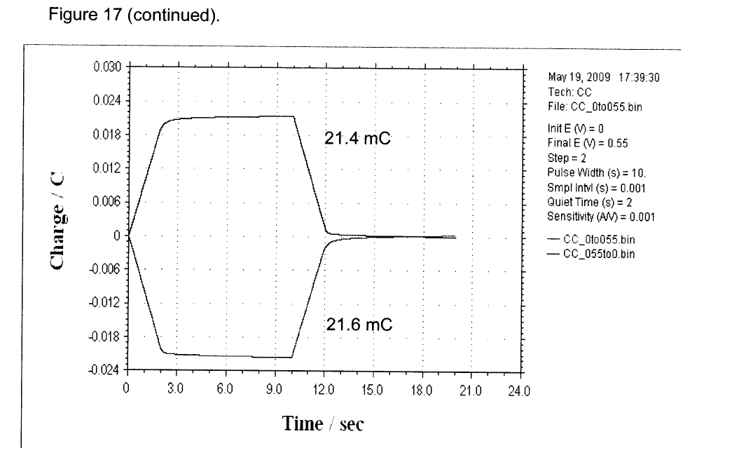

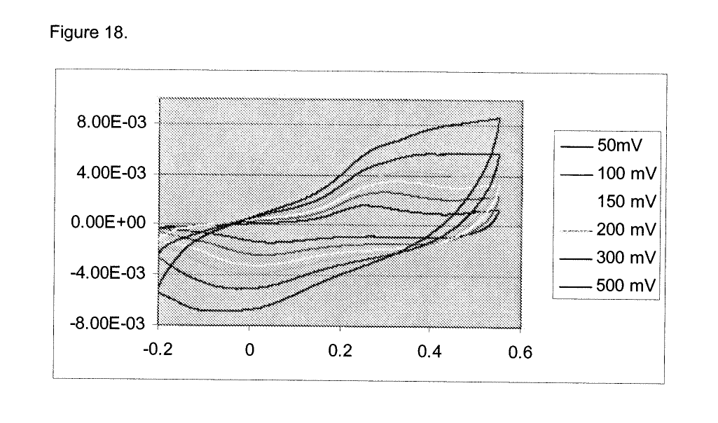

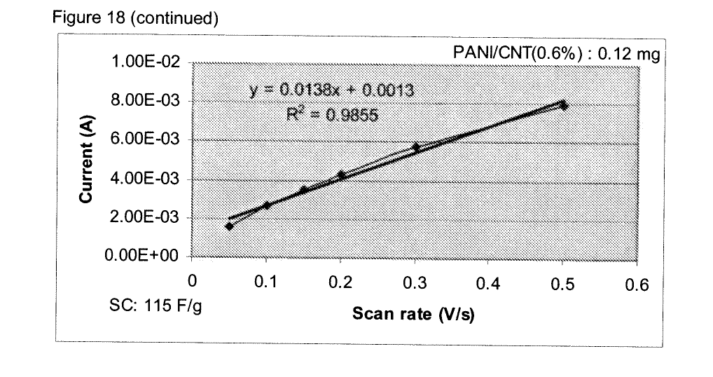

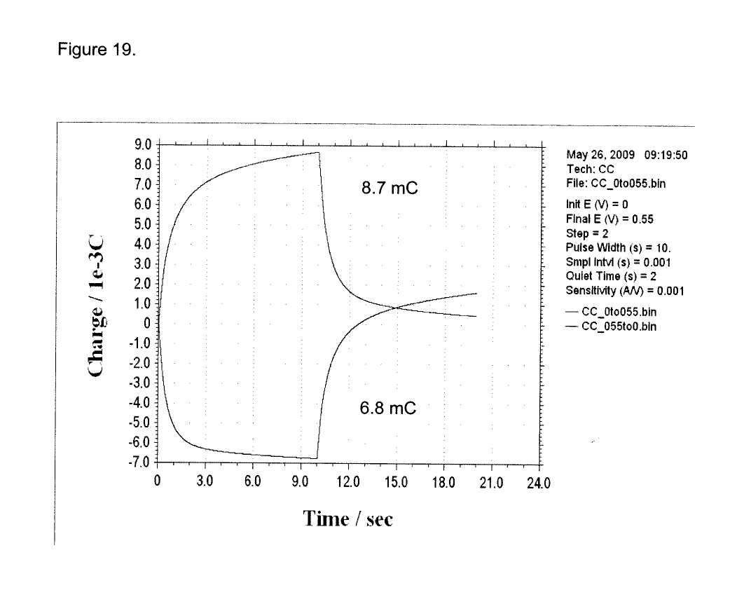

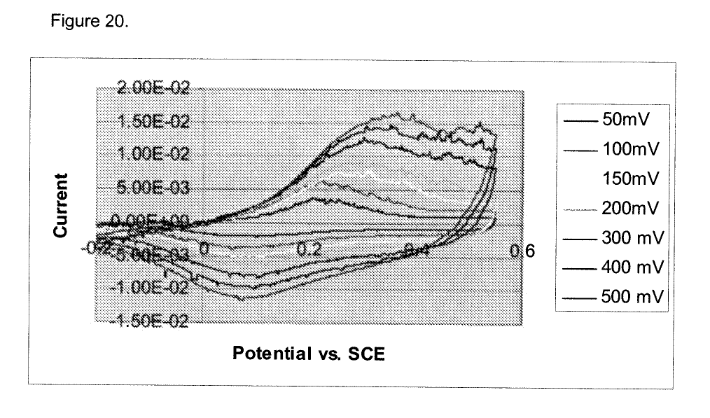

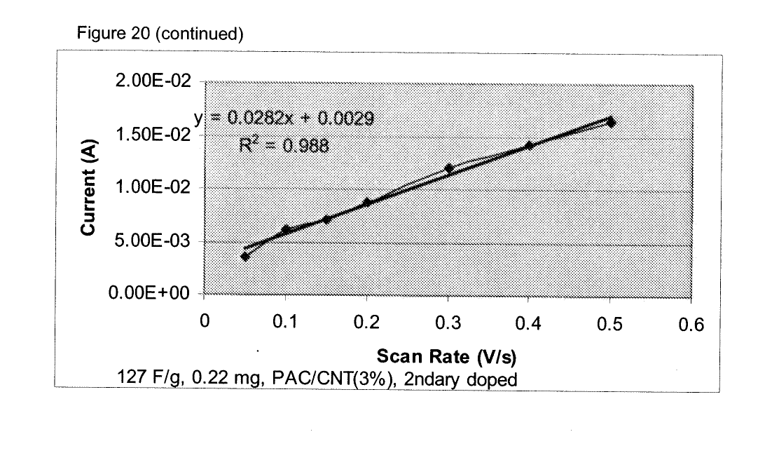

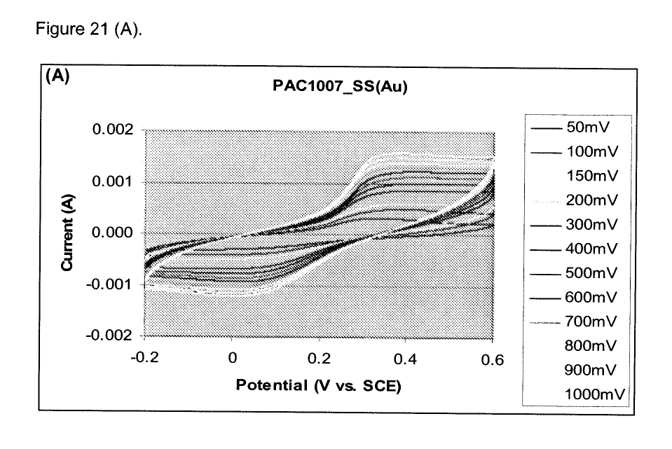

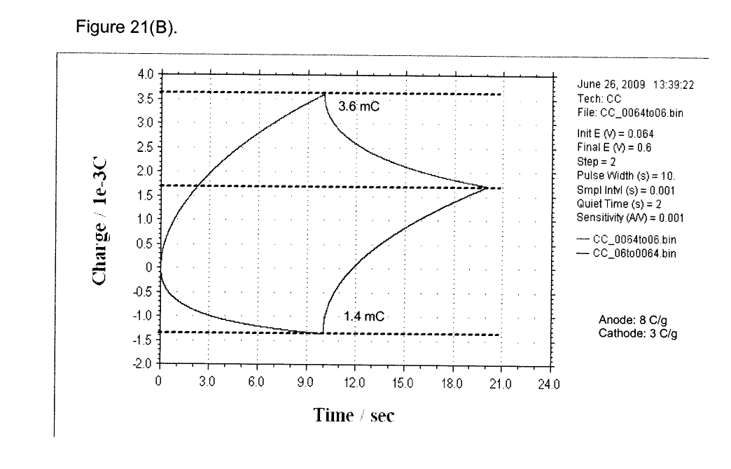

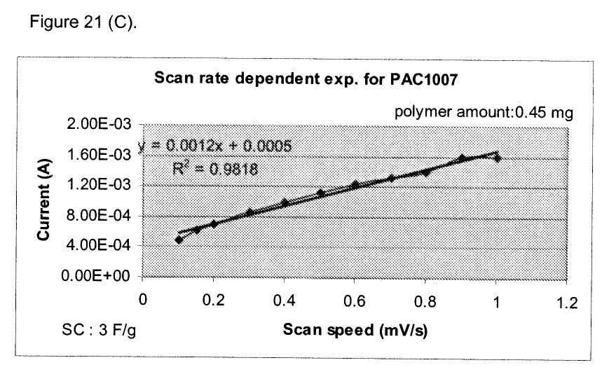

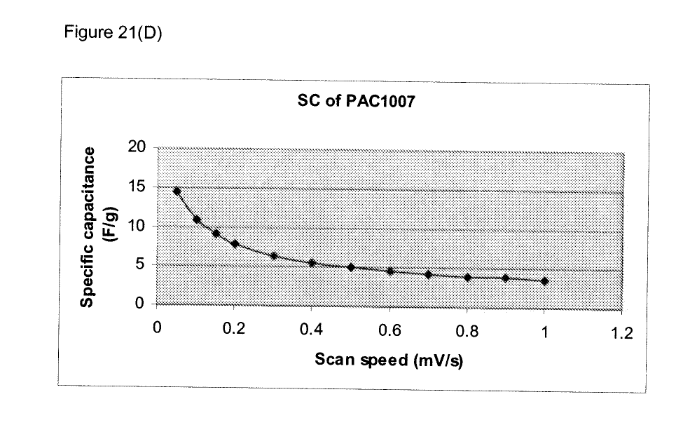

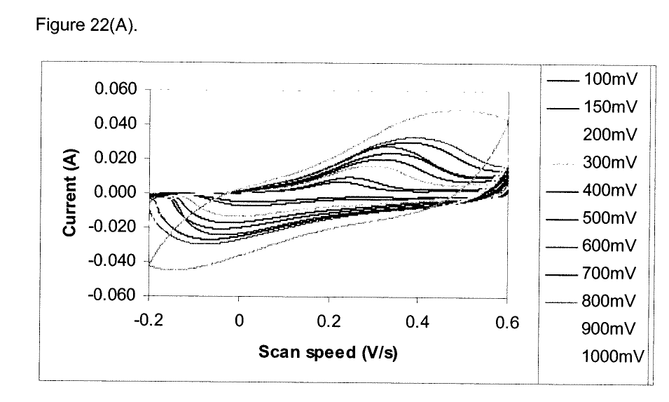

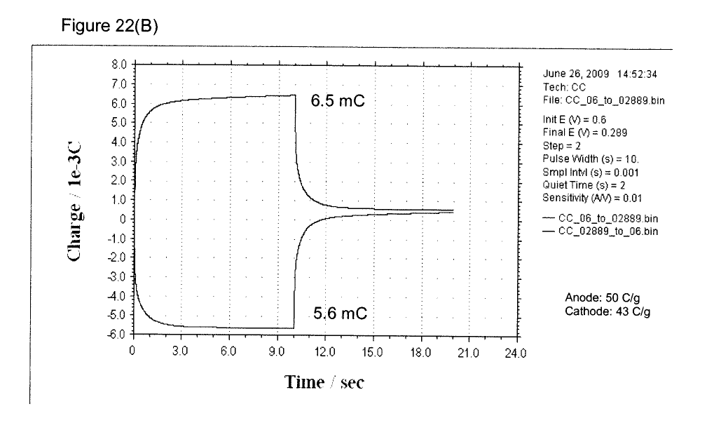

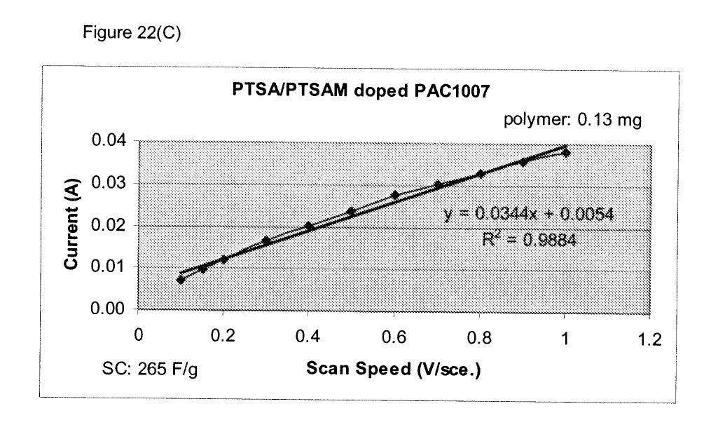

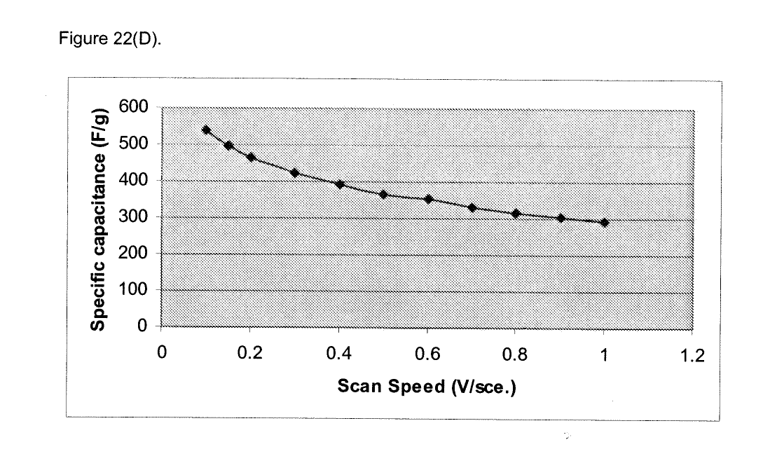

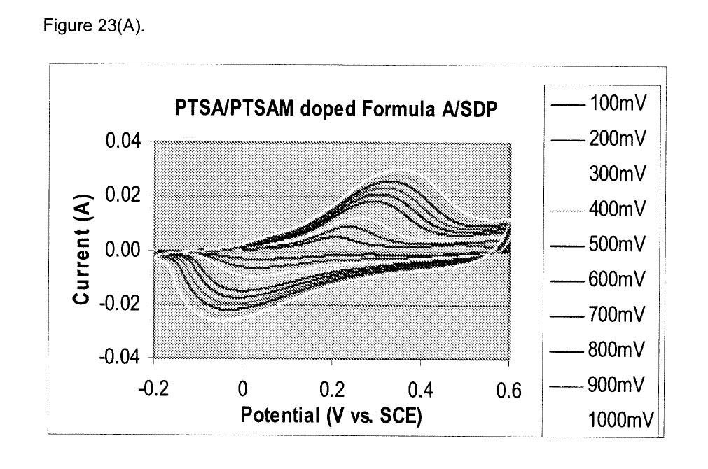

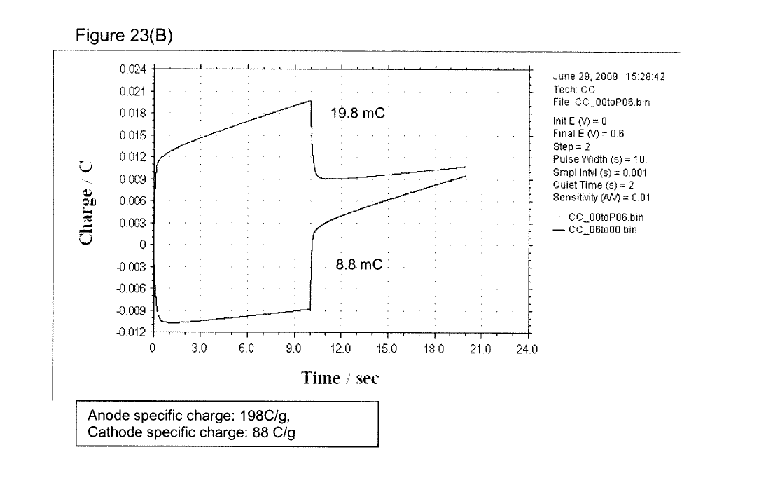

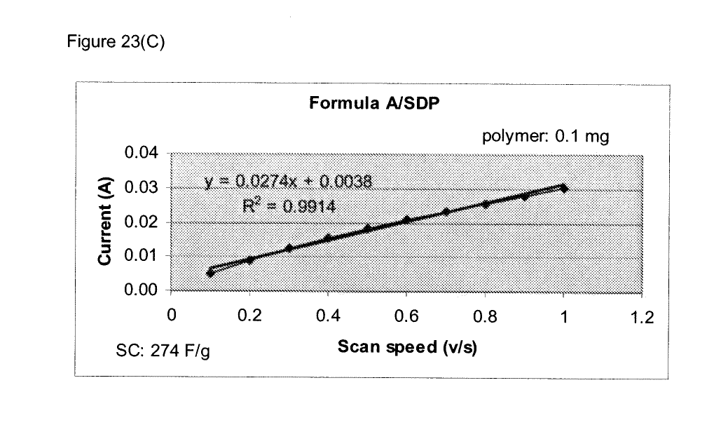

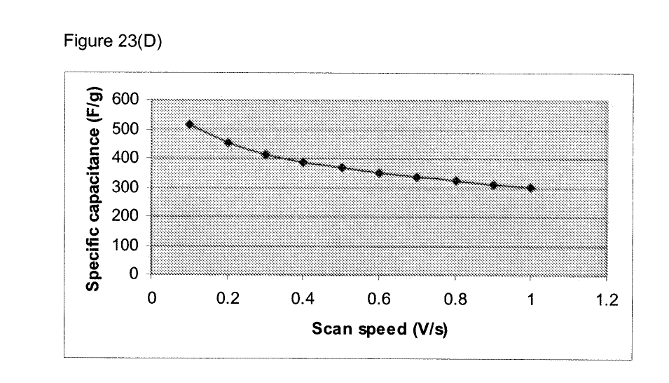

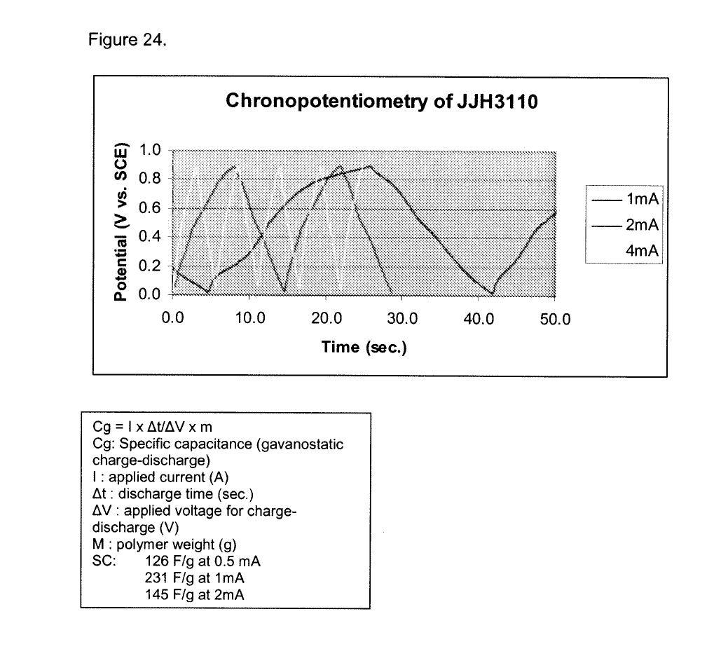

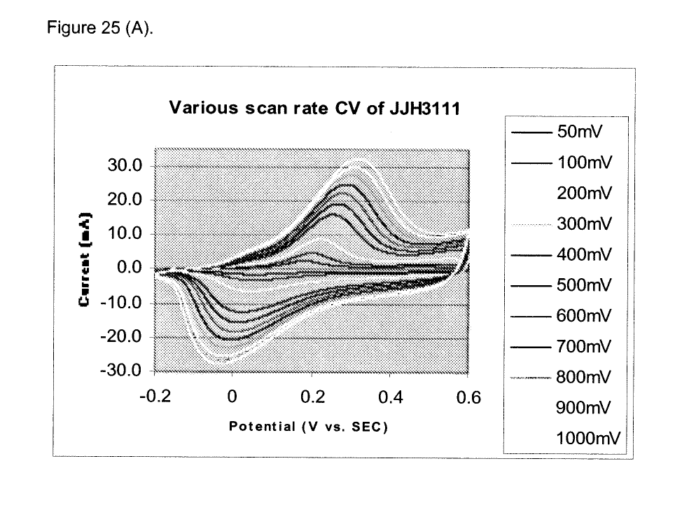

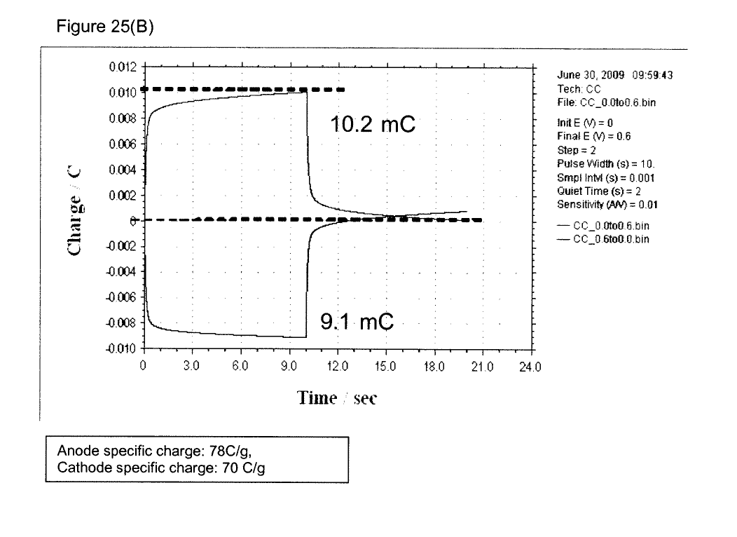

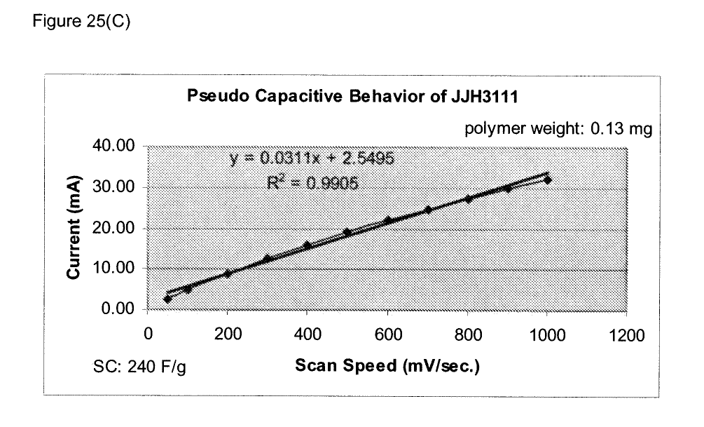

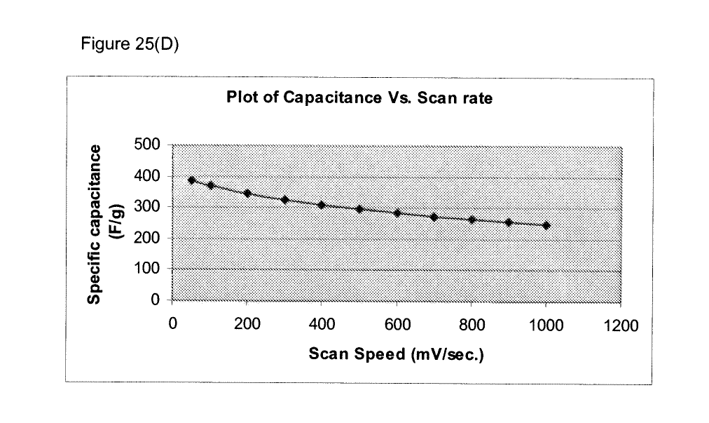

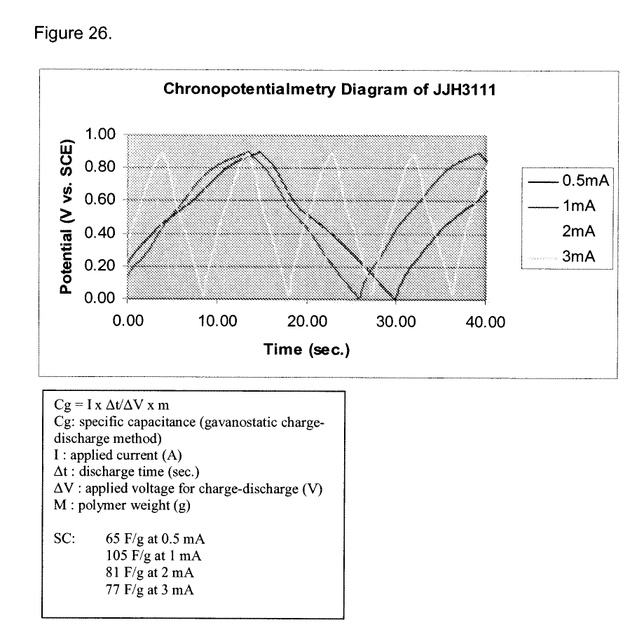

C) Electro-characterization of PAN1/CNT composites in 1.0 M H₂SO₄. The electrochemical characterization of PANI/CNT composites was studied using cyclic voltammetry for capacitance analysis and redox stability, chronocoulometry for equivalent charge analysis of anode and cathode and chronopotentiometry for galvanostatic charge-discharge analysis to obtain capacitance (FIGS. 11-26). To study electrochemical behavior, the 15% w/w PANI/CNT composites in xylene/BCS were coated onto Au interfacial layered stainless steel disks (0.75 inch diameter) via a spin coating method at 2000 rpm for 30 seconds. The thin film was dipped into 5%/OPTSA/0.5% PTSAM in BCS solution for 30 seconds for the secondary doping and was then washed with xylene to remove extra dopant on the film surface. The composite film was treated with heat at 150° C. for 30 minutes in an oven. The cyclic voltammetry (CV) of PANI/CNT composites was carried out with either a Princeton Applied Research Advanced Electrochemical System PARSTAT 2273 or CH instruments CH660C using a typical H-cell configuration. The working, counter and reference electrodes used were SS (Au IFL), Pt gauze (or wire) and standard calomel electrode (SCE) in 1.0 M H₂SO₄. The resulting secondary doped PANI/CNT composite film of 0.2 mg at Au IFL SS (0.75 inch diameter) was subjected to a series of scan rate dependence experiments within the polymer response positive potential window. The composites showed capacitive behavior at moderate scan rates (10-1500 mV/s). The specific capacitance (F/g) values of the composite films were determined as a function of scan rate in the three-electrode electrochemical cell configuration. The specific capacitance of secondary doped PANI/CNT composite was 310 F/g. The specific capacitance (F/g) at 50 mV/s scan rate was 608 F/g. The specific charge and discharge (Coulombs/g) of the composite film were also determined. The specific capacitance and charge-discharge of PANI/CNT composite are shown in Table 8. PANI/CNT capacitance showed that it is enhanced after secondary doping and removing extra dopants as well as slightly enhanced by CNT. FIG. 11 illustrates a cyclic voltammetry diagram, indicating that the capacitance of PANI/CNT composites is enhanced to 62 mF from 3 mF by PTSA/PTSAM doping. The composite made from the emulsion polymerization also showed better redox response (high capacitance) than the solution formulation (blend). The cycling stability of secondary doped Formula A was assessed by a potential sweep between −0.3 and 0.55 V versus Ag/Ag⁺ in 1 M H₂SO₄ and was found to be quite stable (3% loss in capacitance after Cycle 77 in FIG. 16).

TABLE 8
Electro-chemical characterization of PANI/CNT composites in 1.0M H₂SO₄

| | | | | ^{d}Specific | | ^{e}Specific | | Specific | |
|---|---|---|---|---|---|---|---|---|---|
| Formulas | Conditions | ^{c}Capacitance | | capacitance | | charge | | discharge | |
| Formula 7 | PANI/ | 14 | mF | 23 | F/g | | | | |
| (blend), | DBSA_CF | | | | | | | | |
| 0.63 mg | | | | | | | | | |
| Formula 8 | PANI/ | 59 | mF | 168 | F/g | | | | |
| (0.35 mg) | DBSA_CF | | | | | | | | |
| | (washed with BCS) | | | | | | | | |
| EMPAC ™ | PAC3/PTSA/ | 36 | mF | 300 | F/g | 92 | C/g | 79 | C/g |
| 1003 | PTSAM | | | | | | | | |
| (0.1 mg) | | | | | | | | | |
| Formula A | PAC3/CNT | 3 | mF | 4 | F/g | | | | |
| (emulsion) | (0.1%) | | | | | | | | |
| 0.2 mg | PAC3/CNT | 62 | mF | 310 | F/g | 108 | C/g | 107 | C/g |
| | (0.1%) | | | | | | | | |
| | PTSA/PTSAM | | | | | | | | |
| ^{a}Formula A1 | PAC3/CNT | 54 | mF | 181 | F/g | 118 | C/g | 94 | C/g |
| (emulsion) | (0.1%) | | | | | | | | |
| 0.27 mg | PTSA/PTSAM | | | | | | | | |
| ^{b}Formula A2 | PAC3/CNT | 76 | mF | 164 | F/g | 111 | C/g | 103 | C/g |
| (emulsion) | (0.1%) | | | | | | | | |
| 0.6 mg | PTSA/PTSAM | | | | | | | | |
| Formula 1 | PAC3/CNT | 14 | mF | 115 | F/g | | | | |
| (blend), | (0.6%), | | | | | | | | |
| (0.12 mg) | PTSA/PTSAM | | | | | | | | |
| Formula 2 | PAC3/CNT | 25 | mF | 127 | F/g | | | | |
| (blend), | (3.0%), | | | | | | | | |
| (0.2 mg) | PTSA/PTSAM | | | | | | | | |
| EMPAC ™ | | 1.4 | mF | 3 | F/g | 8 | C/g | 3 | C/g |
| 1007 | | | | | | | | | |
| (0.5 mg) | | | | | | | | | |
| EMPAC ™ | PTSA/PTSAM | 36 | mF | 273 | F/g | 50 | C/g | 43 | C/g |
| 1007 | | | | | | | | | |
| (0.1 mg) | | | | | | | | | |
| Formula A/ | CNT (0.1%) | 1.8 | mF | 6 | F/g | | | | |
| SDP | | | | | | | | | |
| (0.3 mg) | | | | | | | | | |
| Formula A/ | PAC3/CNT | 27 | mF | 274 | F/g | 198 | C/g | 88 | C/g |
| SDP | (0.1%) | | | | | | | | |
| (0.1 mg) | PTSA/PTSAM | | | | | | | | |
| Formula B/ | PAC3/CNT | 31 | mF | 240 | F/g | 78 | C/g | 70 | C/g |
| SDP | (0.5%) | | | | | | | | |
| (0.1 mg) | PTSA/PTSAM | | | | | | | | |

All composite films were prepared by spin coating onto SS with Au IFL except formula 7 and 8.
Formula 7 and 8 films were prepared by spray coating onto SS without Au IFL
^{a,b}Repeat experiment. Formula A1 and A2 film surface was not observed to be uniform due to slow spin speed (1000 rpm) during coating process.
^{c}Capacitance values were obtained from scan rate dependent experiment by cyclic voltammetry
^{d}Specific capacitance = capacitance/active material amount
^{e}Specific charge and discharge values were obtained from anode and cathode maximum amount of charge by chronocoulometry.

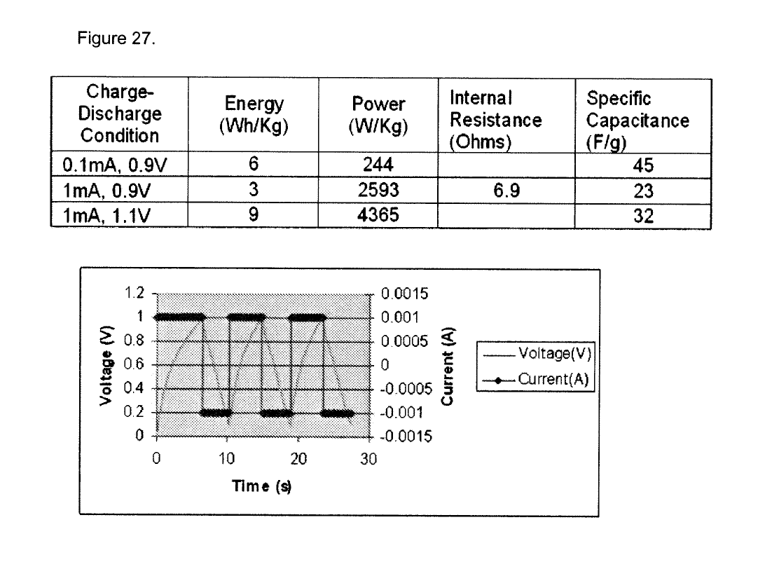

D) Coin cell device performance of PANI/CNTs (0.1% CNT). Coin cells were fabricated using PANI/CNT composite (Formula A) films (as the electrode) deposited on gold-coated stainless steel substrates in a Type I cell configuration. Device performance was evaluated for coin cells containing electrodes composed of PTSA-PTSAM secondary-doped Formula A (0.1% CNT) with EMI-IM ionic liquid as the electrolyte (see FIG. 27). For similar charge-discharge test conditions (1 mA, 1.1V), the inventors determined that PANI/CNT composites yield an optimal energy of 9 Wh/Kg (versus 5 Wh/Kg for pristine PANI) and an optimal power of ca. 4500 W/Kg (versus 130 W/Kg for pristine PANI). From these results, it can be concluded that inclusion of CNT in PANI films may improve the energy by two-fold and power by more than an order of magnitude.

PTSA/PTSAM doped PANI/CNT composites had a much higher capacitance value than primary doped PANI/CNT composites. PTSA/PTSAM doped PANI/CNT composites made by emulsion polymerization exhibited higher capacitance values than PANI/CNTs made by blending with EMPAC™ 1003 and CNTs. PANI/CNT composites proved to be better materials for supercapacitor applications, yielding an optimal energy of 9 Wh/Kg (versus 5 Wh/Kg for pristine PANI) and an optimal power of ca. 4500 W/Kg (versus 130 W/Kg for pristine PANI).

### EXAMPLE 4

Materials

Sigma-Aldrich: Sulfuric acid, Tetrabutylammonium perchlorate (TBAP), Tetrabutylammonium Tetraflouroborate (TBA-BF₄), Tetrabutylammonium hexaflourophosphate (TBA-PF₆), 1-Ethyl-3-methylimidazolium bis(trifluoromethylsulfonyl)imide (EMI-IM), 1-Ethyl-3-methylimidazolium tetraflouroborate (EMI-BF₄), 1-Ethyl-3-methylimidazolium hexaflourophosphate (EMI-PF₆), Bis(trifluoromethane)sulfonimide lithium salt (Li-BTI), Acetonitrile, Propylene carbonate, Lithium perchlorate (LiClO₄), Xylene, and BCS.

Covalent Associates Inc.: 1-ethyl-3-methylimidazolium bis(trifluoromethylsulfonyl)imide (EMI-IM).

CNTs: Brewer Science Inc.: CNTRENE™ C100 (conc. 50 ppm in water); Carbon solution Inc.: P5-SWNT (octyldecylamine functionalized single wall carbon nanotubes).

Spectrcacorp: Porous carbon paper (2055-A-0550).

All materials were used without further purification.

Methods

Synthesis and Characterization of Processible PANI/CNT Composites via Emulsion Polymerization and Solution Formulation (Blending).

Method A:

Emulsion polymerization of aniline in situ dopants and CNT. In this experiment, 0.37 g (3.97 mmol) of aniline and 7.5 g of CNT (0.375 mg) solution (50 ppm in water) were placed into 20 mL vial with a magnetic spin bar. Then, 4.32 g (Nacure® 1051, 4.76 mmol, 1.2 eq) of DNNSA was added to the vial. The mixture was stirred to give an emulsion and the flask was put in an ice bath. The mixture was chilled to between about 0 and 5° C. in an ice bath. Ammonium peroxydisulfate (1.12 g, 4.9 mmol, 1.2 eq) in 2.5 g of DI water was added to the mixture over the course of about 5 minutes and then the mixture was stirred. After 3 hours, the mixture became phase segregated to give a dark green tar top layer and a colorless solution in the bottom layer. 20 g of xylene was added to the mixture and the mixture was poured into a separation funnel. The aqueous layer was removed and 5 or 6 mL of 0.01 M H₂SO₄ was added to remove ammonium byproducts. The organic layer was transferred to a 200 mL flask and the volume was reduced in a Rotoevaporator. The final concentration of PANI/CNT (Formulas A-C) obtained was between 14% and 15% w/w in xylene/BCS (Table 1) based on the reaction condition.

Electro-characterization of PANT/CNT composites. PANI/CNT composites were coated via a spin coating method at 2000 rpm for 30 seconds from a xylene/BCS solvent base onto stainless steel disks (0.75 inch diameter) which were pre-coated with a gold interfacial layer. Cyclic voltammetry (CV) scans of PANI/CNT composites were collected using both PARSTAT® 2273 and CH Instruments CH660C potentiostats in a three-electrode H-cell configuration. The counter and reference electrodes used were Pt gauze or wire and standard calomel electrode (SCE) in case of aqueous electrolytes (1M H₂SO₄). The reference electrode used was Ag/AgNO₃ or Ag wire in non-aqueous electrolytes.

The PANI-CNT composite thin films were prepared as outlined in Example 3.

Preparation of Poly(BEDOT-BBT) coated on Au button electrode. Cyclic voltammetry of monomer was carried out with a Princeton Applied Research Advanced Electrochemical System PARSTAT® 2273 in a three-compartment cell in 5 millimoles of monomer in DCM containing 0.1 M EMI-IM. The polymer was prepared by a cyclic potential sweep technique (−0.4-0.9 V) at a scan rate of 50 mV/s. Solutions were degassed by argon bubbling before use. Pt or Au button (0.2 cm diameter), Pt wire, and 10 mM Ag/AgNO₃ in 0.1 M TBAP/ACN were used as the working, counter and reference electrodes, respectively. Cyclic voltammetry of the polymer was performed in monomer-free electrolyte (0.5 M LiBTI in EMI-IM/PC). The inert gas stream was maintained over the solution during experiment.

Preparation of Poly(BEDOT-BBT) coated on porous carbon paper electrode. Cyclic voltammetry of monomer was carried out with a Princeton Applied Research Advanced Electrochemical System PARSTAT® 2273 in a three-compartment cell in 5 millimoles of monomer in DCM containing 0.1 M EMI-IM.

The polymer was prepared by a cyclic potential sweep technique (−0.4-0.9 V) at a scan rate of 50 mV/s. The solutions were degassed by argon bubbling before use. Porous carbon paper (0.8 cm diameter), Pt gauze, and Ag wire in EMI-IM/PC or 0.5 M LiBTI/EMI-IM/PC blend were used as the working, counter and reference electrodes, respectively. Cyclic voltammetry of the polymer was performed in monomer-free electrolyte (0.5 M LiBTI in EMI-IM/PC). An argon gas stream was maintained over the solution during experiment.

The polymer was prepared by potential pulse (square potential step) techniques. Potential pulse polymerization was applied at −0.4 V for 1 second and 0.85 V for 0.5 seconds, the overall time being 150 seconds.

The polymer was prepared by chronoamperometry method. The polymerization potential was applied at 0.8 V until 500 mC was passed.

Film Characterization: The conductivity of the film was calculated by equation 1 (above).

Instrumentation

Electrochemical characterization: CH Instruments CH 660C and Princeton Applied Research Advanced electrochemical System PARSTAT® 2273.

Resistance measurement: Digital multimeter MASHTECH MS4226 and RS232 interface software.

Film thickness: con-focal microscope and digital micro gauge.

Arbin tester: coin cell charge/discharge experiment for supercapacitor or batteries.

Image display: SEM (scanning electron microscope).

Characterization of processible PANI/CNT as P-dopable (P-Type) polymer.

1. Synthesis and characterization of processible PANI/CNT composites via emulsion polymerization or solution formulation (blending).

Preparation of PANI/CNT Composites.

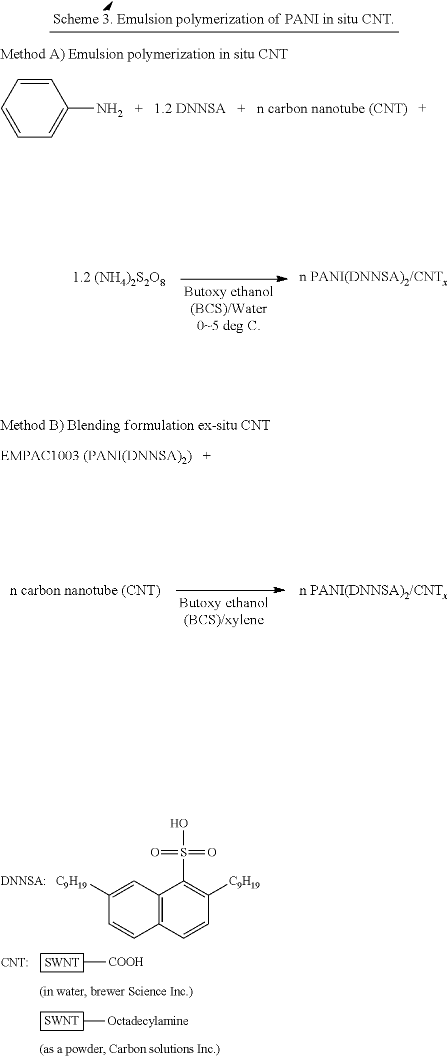

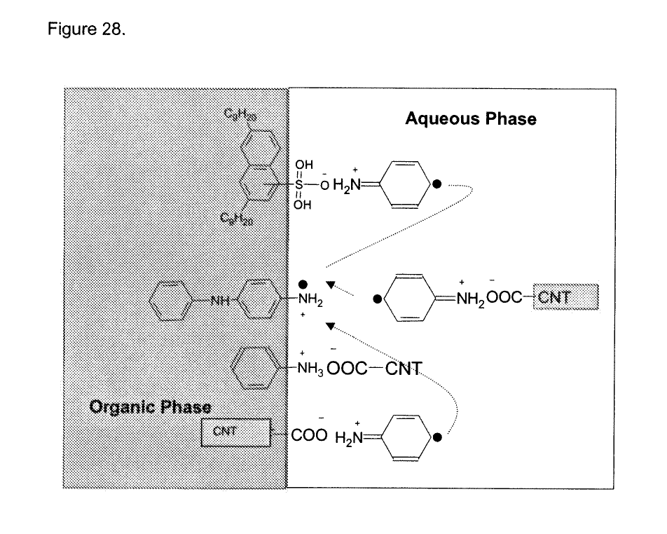

In this example, Method A (emulsion polymerization) was utilized with high concentrated water dispersion CNT solution (500 ppm) from Brewer Science, Inc. Processible PANI/CNT formulations were made with up to 1% CNT (as a percentage of aniline). The diagram in FIG. 28 illustrates a proposed mechanism of emulsion polymerization in situ CNT. Two types of CNTs, one hydrophobic functionalized CNT from Carbon Solution, Inc. and one hydrophilic functionalized CNT (CNTRENE from Brewer Science, Inc.) were evaluated herein. Both PANI/CNT formulations produced processable films.

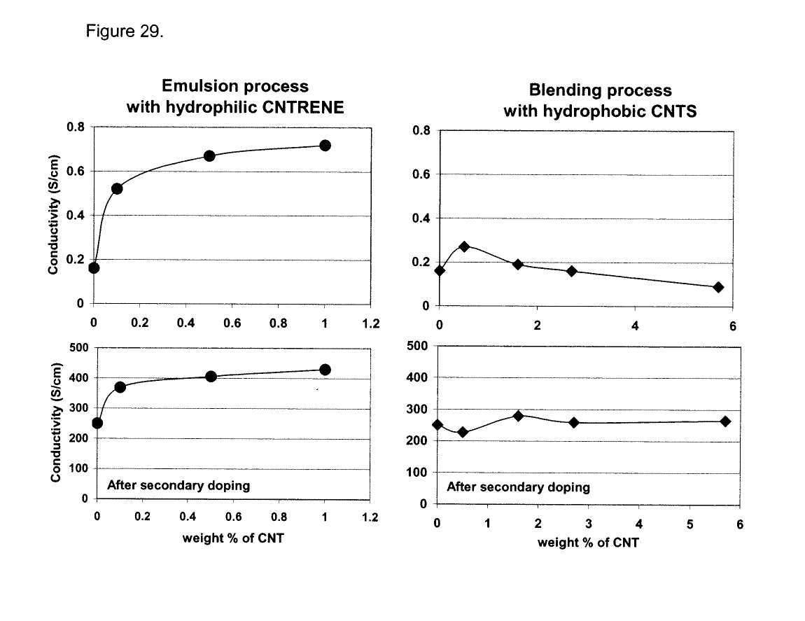

FIG. 29 shows a plot of conductivity versus amount of CNT in PANI/CNT formula/process. Two-probe conductivity measurements were performed by depositing two silver bars onto the PANI/CNT films. As shown by these comparison plots, the PANI/CNT process using hydrophilic functionalized CNTs gave overall higher conductivities than the process with the hydrophobic functionalized CNTs.

Electro-characterization of PANI/CNT formula made from Method A under aqueous (1 M H₂SO₄) and non-aqueous electrolyte (0.2 M TBAP/ACN). Select PANI/CNT composites utilizing CNTs from Brewer Science, Inc. that exhibit high electrical conductivity were coated via a spin coating method at 2000 rpm for 30 seconds from a xylene/BCS solvent onto stainless steel disks (0.75 inch diameter) which were pre-coated with a gold interfacial layer. The PANI/CNT composite film working electrodes were subjected to a series of scans within the polymer response positive potential window in 1M sulfuric acid electrolyte. Specific capacitance (F/g) of the composite film was determined as a function of scan rate in a three-electrode electrochemical cell configuration.

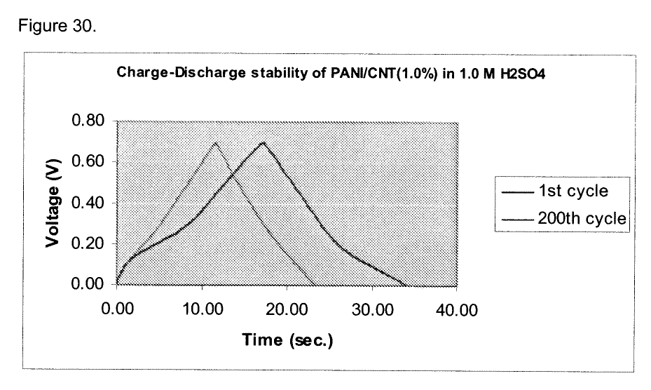

FIG. 30 illustrates the charge-discharge stability of Formula C for 200 cycles. The specific capacitance decreased from 8 mF/cm² to 6 mF/cm². This was decreased by about 30% due to conductivity decrease or increasing space gap between metal surface and polymer.

Formula A was also run in a non-aqueous electrolyte (0.2 M TBAP/ACN). The cyclic voltammogram was very stable for 100 cycles in range from 0.05V and 0.7 V (V versus Ag/AgNO₃) at 100 mV/s. Their current intensity was decreased by less than 3% after 100 cycles.

TABLE 9
Specific capacitances were driven from galvanostatic charge-discharge
exp. (all composite films are doped with PTSA/PTSAM by dipped doping)

| | | | Weight | |
|---|---|---|---|---|
| | Applied current | Areal specific | specific | |
| | and potential | capacitance in | capacitance in | 0.2M |
| | range | 1.0M H₂SO₄ | 1.0M H₂SO₄ | TBAP/ACN |
| Formula A | 0.5 mA, 0.8 V | 16 mF/cm² | 165 F/g | 4 mF/cm² |
| (emulsion), 0.27 mg | | | | (43 F/g) |
| | 1.0 mA, 0.8 V | 15 mF/cm² | 157 F/g | 3 mF/cm² |
| | | | | (33 F/g) |
| Formula B | 0.5 mA, 0.7 V | 7 mF/cm² | 107 F/g | |
| (emulsion), 0.19 | 1.0 mA, 0.7 V | 8 mF/cm² | 113 F/g | |
| Formula C | 0.5 mA, 0.7 V | 8 mF/cm² | 175 F/g | |
| (emulsion), 0.13 | 1.0 mA, 0.7 V | 8 mF/cm² | 181 F/g | |

Electric conductivity test in PANI/CNT formula in various electrolytes. The electric properties of PANI/CNT formulas were monitored in various electrolytes to determine decreasing capacitance. More specifically, surface conductivity was monitored over time. Initially, the conductivity decreased quickly and then began slowly decreasing. In addition, acidic electrolytes helped lessen the decreasing conductivity (Table 10).

TABLE 10
Percent conductivity of PANI/CNT formula
over time in various electrolytes

| | Secondary doped PANI/CNT | |
|---|---|---|
| | Remaining % conductivity | Test time |
| EMI-IM | ^{a}12% | 20 hs |
| EMI-IM/PC (v/v 1/1) | ^{b}11% | 20 hs |
| 0.06M PTSA in | ^{a}20% | 5 hs |
| EMI-IM/PC (1/1) | | |
| 0.06M PTSA in | ^{b}20% | 20 hs |
| EMI-IM/ACN (1/1) | | |

^{a}Formula A (PANI/0.1% CNT),
^{b}Formula B (PANI/0.5% CNT)

2. Electro-characterization of secondary doped EMPAC™ 1003 in various non-aqueous supporting electrolytes. The redox capacitance of PANI is very high in acidic aqueous supporting electrolytes due to their high ionic conductivity.

TABLE 11
Capacitance and specific capacitance of secondary doped EMPAC ™
1003 in various supporting electrolytes under three electrodes cell.

| | | Secondary doped |
|---|---|---|
| | | EMPAC ™ 1003 |
| | Capacitance | Area specific |
| | (mF) | capacitance (mF/cm²) |
| 0.1M LiClO₄/PC | 1.6 | 39 |
| 0.1M TBAP/PC | 1.9 | 47 |
| 0.2M TBAP/ACN | 6.3 | 158 |
| 0.2M TBAPF₆/PC | 1.8 | 45 |
| 0.2M LiBTl/PC | 3.7 | 92 |
| 0.2M EMIPF₆/PC | 2.8 | 71 |
| 1.0M TBABF₄/PC | 5.2 | 131 |
| EMI-IM (IL) | 4.6 | 116 |
| 0.5M PTSA in | 4.1 | 181 |
| EMI-IM/PC | | |

Preparation of PANI working electrode: 5% EMPAC ™ 1003 solution film was made by drop casting onto Au button (φ = 0.2 cm) then drying at 150° C. for 30 min. The film was dipped into a secondary dopant solution for 30 sec. (×2) followed by drying at 150° C. for 30 min. Counter and reference electrodes used as Pt gauze and Ag/AgNO₃.

Table 11 illustrates the effect of solvent and supporting electrolyte on the specific capacitance of EMPAC™ 1003 films.

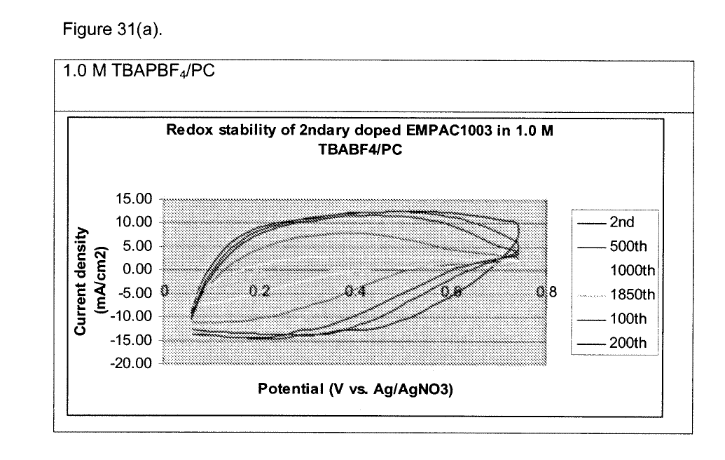

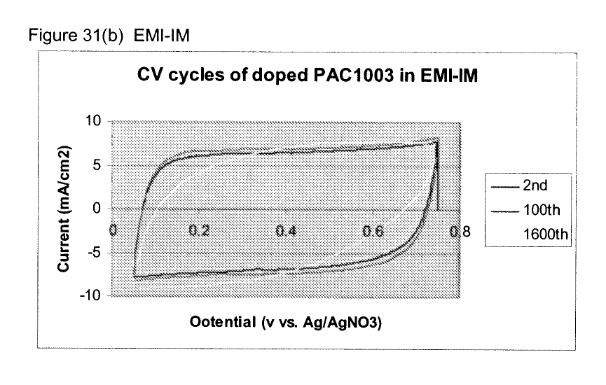

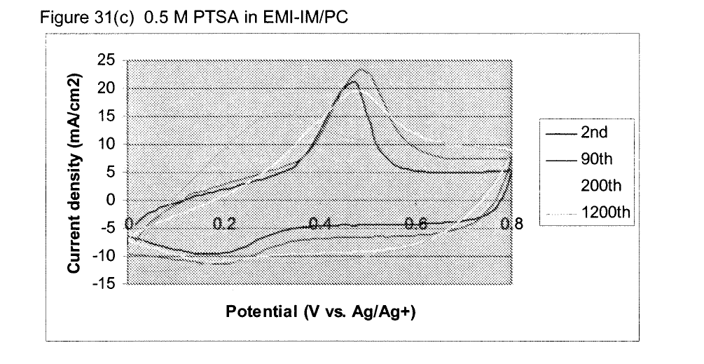

In FIG. 31, PANI was electro-characterized for redox stability with 1.0 M TBABF₄/PC, EMI-IM or 0.5 M PTSA in EMI-IM/PC blend at 50 mV/s between 0.05 and 0.7 V (V versus Ag/AgNO₃).

TABLE 12
Capacitance results for PANI with 0.5M PTSA
in EMI-IM/PC blend as supporting electrolyte.
E-characterization secondary doped EMPAC ™ 1003
Working electrode: PANI coated onto Au button
(0.2 cm diameter) Reference electrode: Ag wire;
Counter electrode: Pt wire Supporting electrolyte:
0.5M PTSA in EMIIM/PC 1/1 v/v blending

| | | Area specific | Area specific capacitance |
|---|---|---|---|
| | | capacitance | (mF/cm²) |
| | Capacitance | (mF/cm²) by scan | Galvanostatic charge- |
| | (mF) | rate dependant | discharge 0.1 mA, 0.8 V |
| 1^{st} run | 4.1 | 181 | |
| 2^{nd} run | 9.1 | 227 | |
| 3^{rd} run | 7.8 | 194 | 211 |
| 4^{th} run | 7.3 | 183 | 219 (251 for 0.04 mA) |

1^{st} run: initial run
2^{nd} run: after 100^{th} potential sweep cycles
3^{rd} run: after additional another 100^{th} potential sweep cycles
4^{th} run: after additional 1000^{th} potential sweep cycles

The acidic EMI-IM/PC blend, as a supporting electrolyte, provided the best performance (conductivity and redox stability) for PANI supercapacitor applications.

Characterization of Poly(BEDOT-BBT) as N-dopable (N-type) Polymer.

1. Poly(BEDOT-BBT) was coated on Au button (0.2 cm diameter) by electropolymerization in three electrodes

The polymer was electrochemically polymerized (deposited) from a 5 millimoles of monomer in 0.1 M LiClO₄/DCM or 0.1 M EMI-IM/DCM solution (25 mL) onto each of Au button, via a repeat scan cyclic voltammetry method. Au button (0.2 cm diameter), Pt wire, and Ag/AgNO₃ were used as the working, counter and reference electrodes, respectively. CV of the polymer was performed in monomer-free electrolytes. The argon gas stream was maintained over the solution during the experiment.

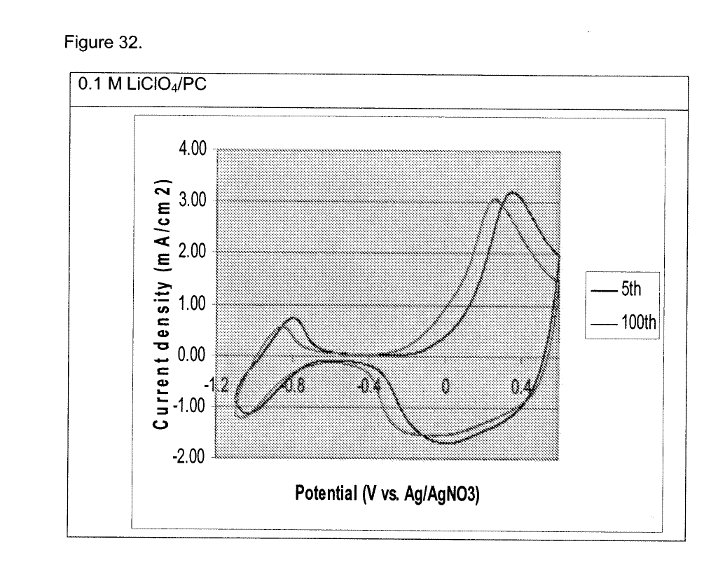

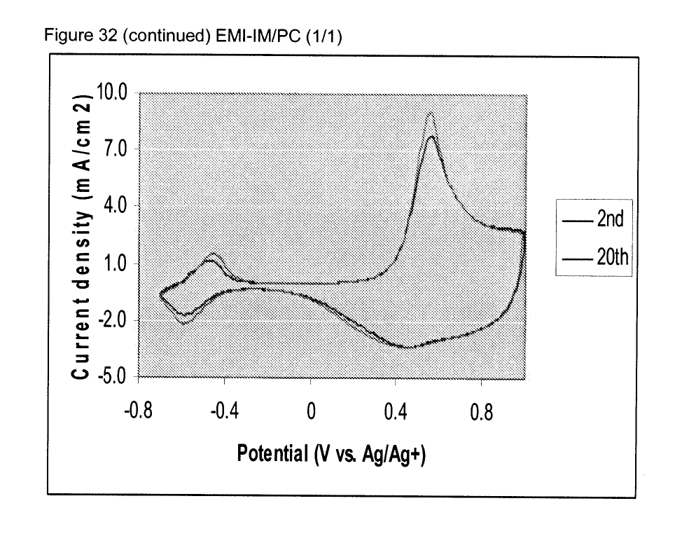

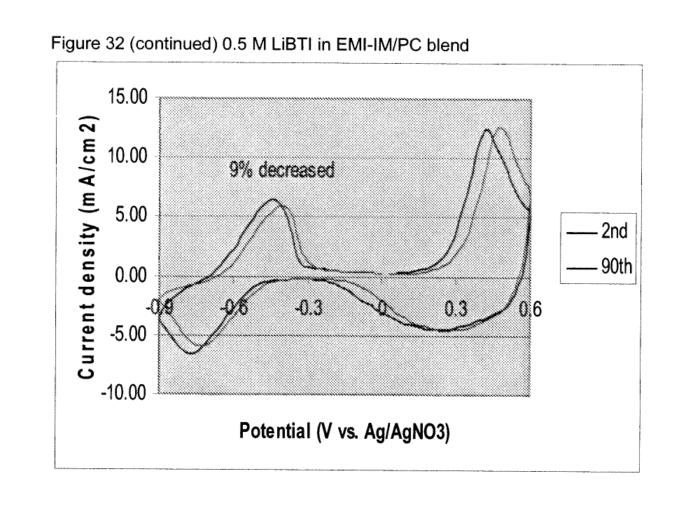

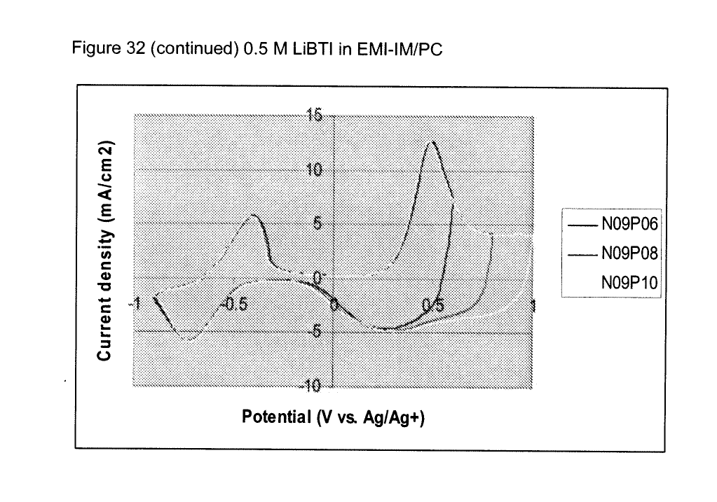

Electro-characterization of Poly(BEDOT-BBT) with 0.1 M LiClO₄/PC, EMI-IM/PC and 0.5 M LiBTI in EMI-IM/PC blend as supporting electrolytes. As shown in FIG. 32, the polymer was relatively stable in these electrolytes.

Redox capacity was displayed in the order of EMI-IM/PC<0.1 M LiClO₄/PC<0.5 M LiBTI/EMI-IM/PC. EMI-IM as an ionic liquid also has an advantage to extend the potential window. The 0.5 M LiBTI in EMI-IM/PC electrolyte resulted in good capacitive properties, having a large potential window (1.9 V) with Poly(BEDOT-BBT).

The resulting polymer film at the Au button was subjected to a series of scan rate dependence experiments within the polymer response potential. The polymer film shows capacitive behavior at moderate scan rates of 20-100 mV/s. Specific areal capacitance of the polymer film was determined as a function of scan rate in a three electrode electrochemical cell configuration (Table 12). Results show that capacitance of Poly(BEDOT-BBT) doubled when using 0.5 M LiBTI in EMI-IM/PC blend. In addition, their capacitance was not changed after 100 redox cycles. The 0.5 M LiBTI in EMI-IM/PC supporting electrolyte was appropriate for a type III supercapacitor application.

TABLE 13
The capacitance of POLY(BEDOT-BBT) in EMI-IM/PC and
0.5M LiBTl/EMI-IM/PC blend supporting electrolytes.

| | | | | Area specific |
|---|---|---|---|---|
| | | | Area specific | capacitance |
| | | Capacitance | capacitance | (mF/cm2) after |
| | | (mF) | (mF/cm2) | 100 cycles |
| EMI-IM/PC (1/1) | N-type | 1 | 25 | |
| | P-type | 3 | 74 | |
| 0.5M LiBTl in | N-type | 2.4 | 60 | 60 (2.4 mF) |
| EMI-IM/PC (1/1) | P-type | 5 | 143 | 154 (6.2 mF) |

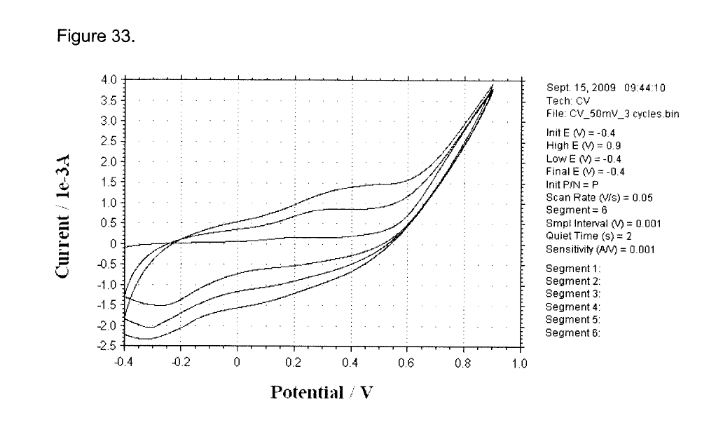

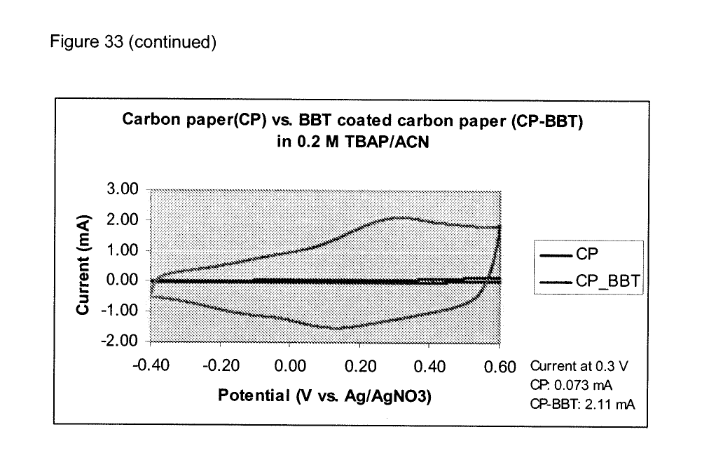

2. Poly(BEDOT-BBT) was coated on porous carbon paper by electropolymerization in three electrodes. High capacitance conducting polymer was coated on porous carbon paper (large surface). Poly(BEDOT-BBT), as n-type polymer, was electrochemically polymerized (deposited) from a 3 mM or 1 mM concentration monomer in 0.1 M TBAP/DCM solution onto each of Pt button, Au button, ITO coated glass, stainless steel, and Au interfacial layered stainless steel via repeat scan cyclic voltammetry at −0.4 V-0.9 V as well as chronoamperometry method was applied at 0.8 V (versus Ag/AgNO₃). Electropolymerization of a monomer, BEDOT-BBT, was carried out using a porous carbon paper substrate. The polymer was coated onto a carbon paper surface (2 cm diameter) with two different electropolymerization techniques. Potential sweep cyclic voltammetric method was used as a conventional method (FIG. 33A). Another method used was the potential pulse polymerization technique.

Poly(BEDOT-BBT) coated on carbon paper increased the capacity in the CV diagram, increasing current at the same rate as potential, in comparison with pure carbon paper and polymer coated on carbon paper (FIG. 33B).

The capacitance of carbon paper and polymer coated carbon paper was obtained from the slope of current at 0.4 V (versus Ag/AgNO₃) with various scan rates. The capacitance of carbon paper (2 cm diameter) was determined to be about 0.7 mF (28 μF/cm²) in 0.2 M TBAP/ACN (FIG. 34A). The capacitance of Poly(BEDOT-BBT) coated on carbon paper (2 cm diameter) was determined to be about 7.6 mF (303 pF/cm²) in 0.2 M TBAP/ACN. Poly(BEDOT-BBT) coated carbon paper gives higher capacitance values than pure carbon paper (FIG. 34B).

SEM images studies of carbon fabric mat carbon paper and POLY(BEDOT-BBT) coated PANT (see FIG. 35). To visualize polymer coated carbon paper work, scanning electron microscope (SEM) images were prepared. The SEM image showed a controlled carbon fabric mat and paper. The carbon fabric mat was shown by ordered stacking fiber form (10 μm diameter). The carbon paper was shown by random network fiber form (5 μm diameter). The carbon paper appeared as a fishnet in low magnified SEM image and the surfaces were very clean. The SEM images of the carbon paper containing Poly(BEDOT)-BBT showed small localized islands of Poly(BEDOT-BBT) on the carbon network. A comparison of the images obtained for the potential sweep and potential pulse methods suggests that more materials were deposited onto the carbon surface through the pulse method.

3. Electro-characterization of Poly(BEDOT-BBT) coated on porous carbon paper in two electrodes (T-cell). A T-cell was built with Poly(BEDOT-BBT) on carbon paper as electrodes, separator and supporting electrolytes using EMI-IM/PC blend.

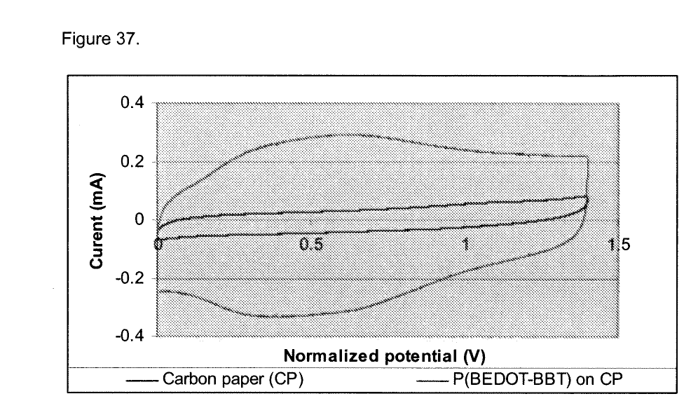

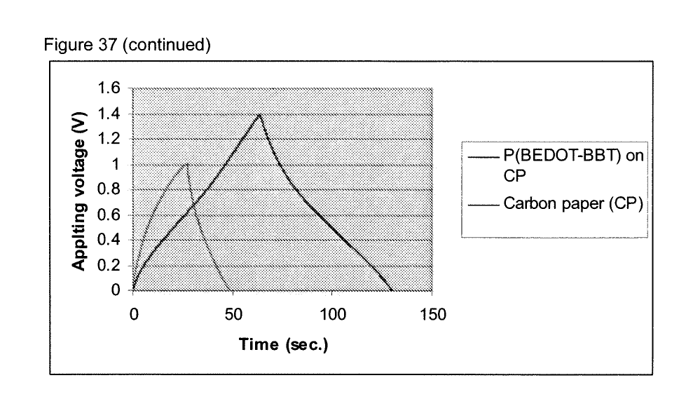

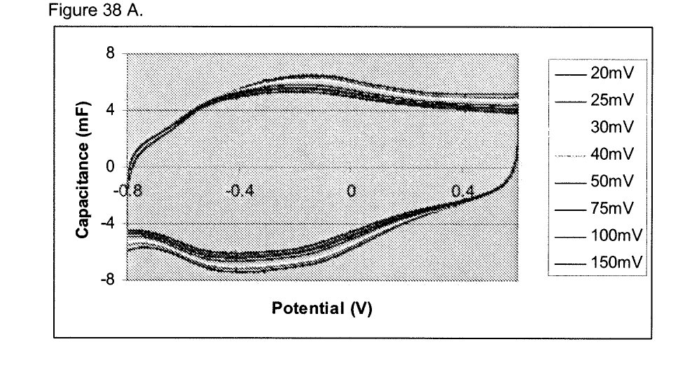

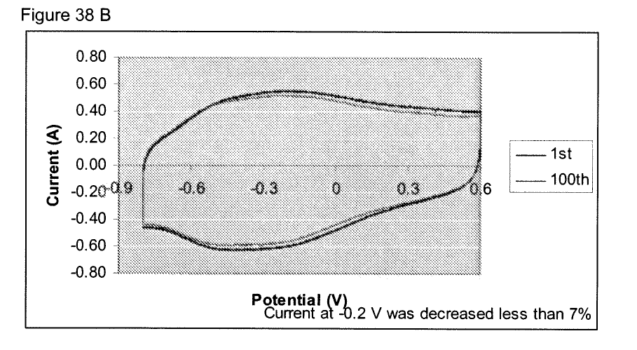

The working electrode used Poly(BEDOT-BBT) was coated on porous carbon paper (1.8 cm diameter, 2.54 cm2, 0.01677 g) and a separator (Gore) was placed between the two carbon electrodes. The supporting electrolyte was then charged. Redox data is shown in FIG. 37. The capacitance of carbon paper (controlled value) was 0.7 mF from three electrodes, 0.5 mF from CV with two electrodes and 0.7 mF from galvanostatic charge-discharge under three different experimental. However, the capacitance of Poly(BEDOT-BBT) coated on carbon paper was 5.3 mF at 0.1 mA, for 1.4 V. In addition, the capacitance of Type-III open cell was not much different for various scan rates (FIG. 38A). The redox cyclic stability of the Type-III open cell proved to be very stable for 100 cycles (FIG. 38B).

TABLE 14
Galvanostatic charging-discharging of carbon paper (CP) versus
POLY(BEDOT-BBT) on CP

| | | | Charging | Discharging | Capacitance, mF | | Capacitance |
|---|---|---|---|---|---|---|---|
| | mA | V | time (s) | time (s) | charging | discharging | From CV (mF) |
| CP | 0.05 | 1 | 27.2 | 20.8 | 1.36 | 1.04 | 0.6 |
| | 0.1 | 1 | 9 | 7 | 0.9 | 0.70 | |
| POLY(BEDOT- | 1 | 1.4 | 5.4 | 5.7 | 3.86 | 4.07 | 5.3 |
| BBT) | 0.1 | 1.4 | 63.9 | 66.1 | 4.56 | 4.72 | |
| on CP | 0.025 | 1.4 | 296 | 310 | 5.29 | 5.54 | |

4. Chemical polymerization of BEDOT-BBT onto porous carbon paper (preliminary result). Composite electrodes for supercapacitors were prepared via chemical polymerization of BEDOT-BBT on the surface of a porous carbon paper matrix by the dipping method. The chemical polymerization method operating conditions are shown in Table 15.

TABLE 15
Operating conditions for P(EDOT-BBT)/carbon paper electrode

| Step | Operation | Medium | Duration |
|---|---|---|---|
| 1 | Immersion in | 5 mM EDOT- | 30 min. |
| | monomer solution | BBT in CH₂Cl₂ | |
| 2 | Immersion in | 0.1M oxidant | 20 min. |
| | oxidizing solution | (FeCl₃) in | |
| | | acetonitrile | |
| 3 | Subsequent | Methanol | 10 min. (×4) |
| | rinsings (4 times) | | |
| 4 | Drying | | Hot air |

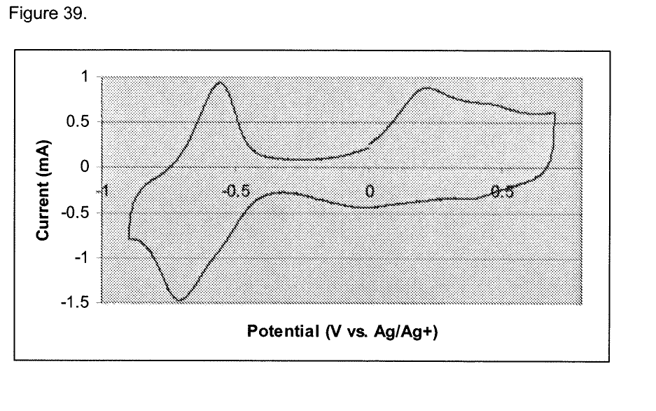

The Poly(EDOT-BBT)/carbon paper composite was electro-characterized with the three electrodes configuration. The counter and reference electrodes used were Pt wire and Ag wire. The supporting electrolyte used was a 0.5 M LiBTI/EMI-IM/PC blend. The CV diagram (FIG. 39) illustrates an n-dopable scan at 50 mV/s between −0.9 and 0.7 V (V versus Ag/Ag+) in 0.5 M LiBTI/EMI-IM/PC blend. The CV showed that chemical polymerized Poly(BEDOT-BBT) has greater n-dopable capacity than electro-polymerized Poly(BEDOT-BBT).

Hydrophilic functionalized CNT provided better conductivity than hydrophobic functionalized CNT in a processable PANI/CNT formula. The surface conductivity of PANI/CNT film was enhanced by increasing CNT amounts under primary doping. N-dopable Poly(BEDOT-BBT) coated on carbon paper gave 10 times higher capacitance values (7.6 mF) than pure carbon paper (0.7 mF).

### EXAMPLE 5

This example illustrates the preparation of a composite with SWCNT and PANI DNNSA that is highly conducting. An emulsion polymerization was run with aniline/SWCNTs/DNNSA using ammonium peroxy disulfate as an oxidizing agent. Carbolex AP grade 12-15A diameter SWCNTs were obtained from Aldrich [cat. number 5(930-8)]. As a first step, SWCNTs were dissolved in aniline.

Calculations:
0.06 moles aniline
mw=93.13
p=1.022 g/ml
0.06 93.13=5.6 g aniline

0.0127 grams of carbon nanotubes were measured into a 27.25×70 ml vial and then added 5.5 ml of aniline [99.5+% a.c.s. reagent grade] with stirring. An ultrasonic bath was then employed for 10 minutes.

Polymerization Reaction:

46.1 g DNNSA [46.1×2=92.2 g of a 50% solution] and 89.93 g of Nacure® 1051 (King Industries) were added to a 500 ml Erlenmeyer flask. 20 ml distilled water was added to the Nacure® 1051 mixture. An additional 270 ml of distilled water was then added and the mixture was then transferred to a 1 L beaker. The carbon nanotube aniline solution was then added to the reaction vessel.

18.08 g of ammonium persulfate was then dissolved in 40 ml distilled water. This solution was then added dropwise to the DNNSA/aniline/carbon nanotube emulsion. The emulsion turned to an amber color.

The reaction mixture was stirred in an aluminum foil-covered 1 L beaker for an additional 30 hours. Upon reopening, a dark-green reaction product was observed. The mechanical stirrer was removed and the solution was rinsed with xylene into a clean beaker. The solution was a light blue-green color. Water was added to the xylene rinse solution and it separated into two phases: the upper phase was blue-green in color and the bottom phase was colorless and clear. The solution was then washed twice with 100 ml distilled water in a 500 ml separatory funnel. The diluted solution was placed in the spectrophotometer.

The remaining reaction mixture was added to a 2 L separatory funnel. 750 ml distilled water and 500 ml xylene were added to the reaction beaker to clean out leftover product. This solution was then transferred to the separatory funnel.

The product was washed three times with 500 ml distilled water and concentrated in the Rotoevaporator down to about 70 grams of finished product at 57% solids.

A second batch of PANI-CNT was prepared as set forth above. However, this time, 0.1139 g CNT was added to 5.54 grams aniline. This mixture was sonicated for 20 minutes, yielding a thick paste. 91 grams of Nacure® 1051 was added to a 1 L beaker followed by 500 ml of water and the CNT-aniline paste. To aid in emulsification, the liquid was transferred to a Waring® blender and blended on high for about 2 minutes. The emulsified mixture was then transferred back to the 1 L beaker.

An air driven mixer was used to stir the solution, which was cooled with a NaCI ice bath down to 2-3° C. Ammonium peroxydisulfate (17.86 grams/40 ml DI water) was then added dropwise to the cooled reaction mixture. The mixture was allowed to stir overnight. The reaction mixture work-up was the same as described above.

A third batch of PANI-CNT was prepared as set forth above. This time 0.9893 g CNT was added to 5.63 grams aniline. This mixture was sonicated for 20 minutes and the polymerization reaction and work-up were run as described above.

Draw-downs of the above solutions were made on polycarbonate using a doctor blade. The films were then dried at 140° C. for 2.5 minutes. They were then washed with methanol to activate. The specifications for each run are shown in Table 16.

TABLE 16

| | | | | | Ohm/SQ |
|---|---|---|---|---|---|
| | | | Nacure | | (After |
| Run | Aniline | SWCNT | 1051 | Oxidizer | MeOH |
| Number | (grams) | (grams) | (grams) | (grams) | Wash) |
| 1 | 5.6 | 0.0127 | 92.2 | 18.08 | |
| 2 | 5.54 | 0.1139 | 91.0 | 17.86 | 167 |
| 3 | 5.63 | 0.9893 | 91.3 | 18.0 | 11100 |

### EXAMPLE 6

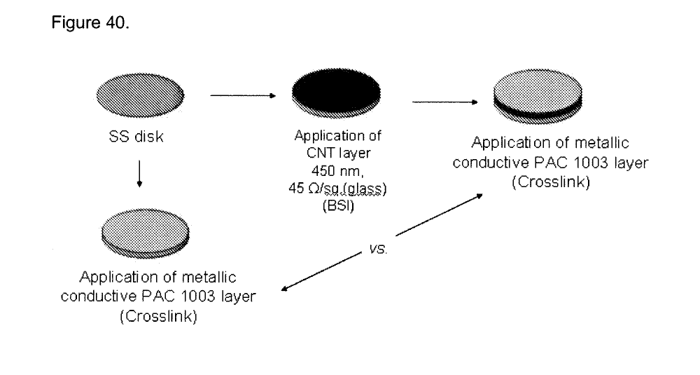

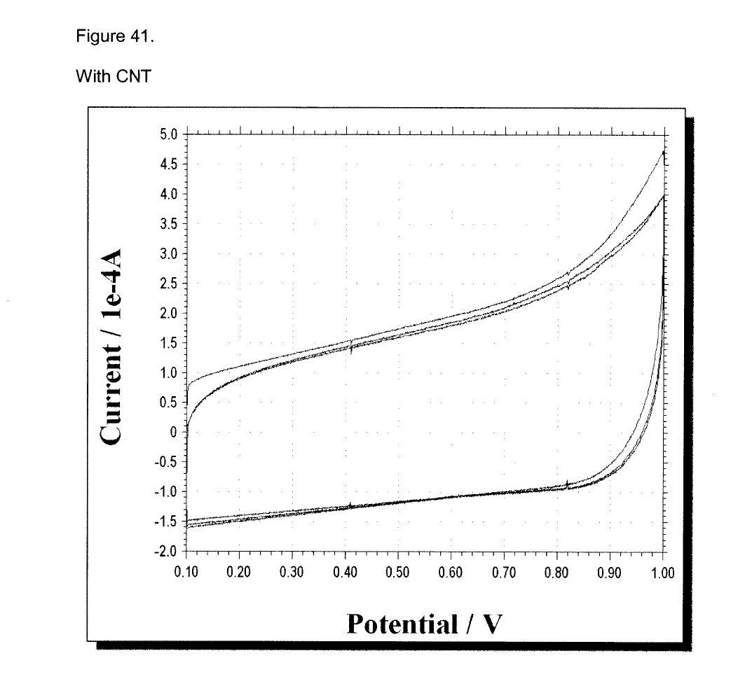

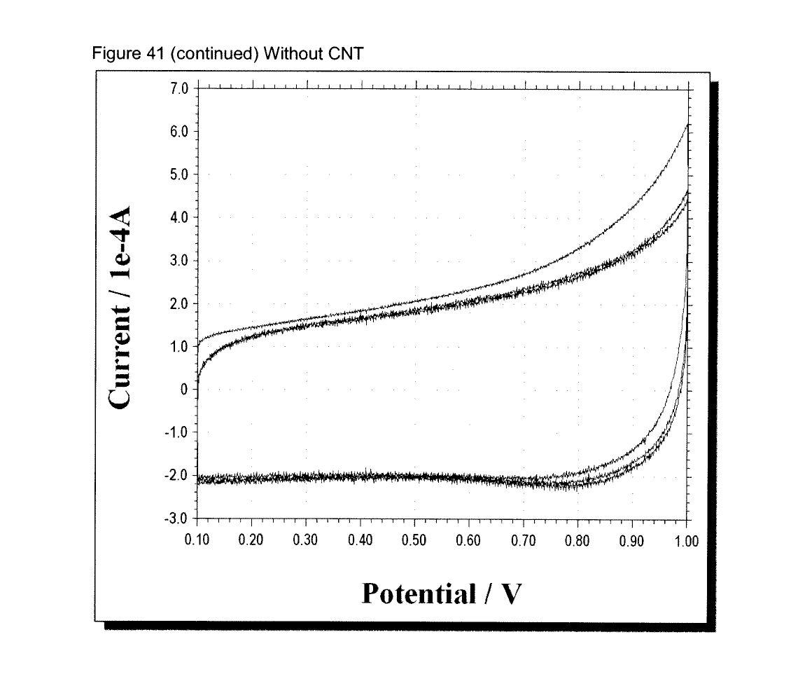

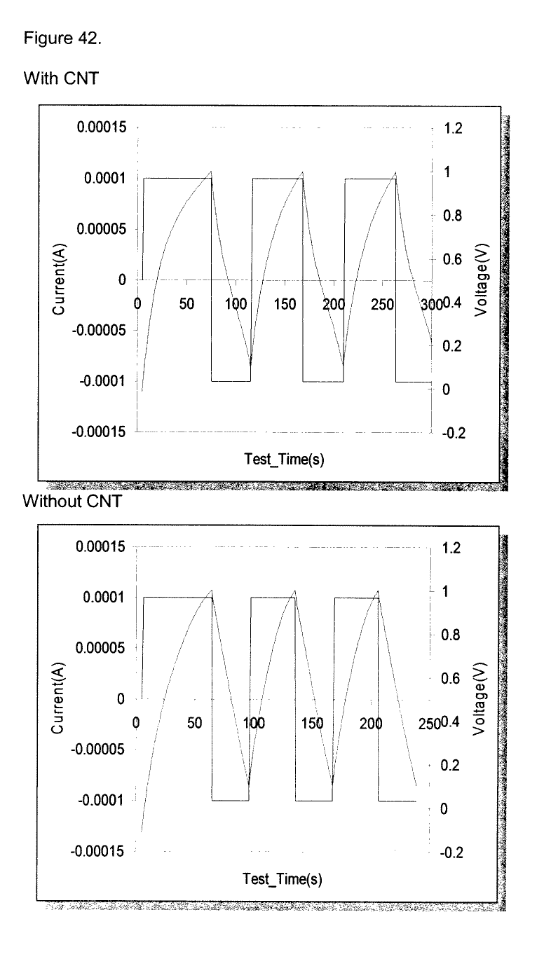

As a way of reducing the volume of supercapacitor modules, thick separators and SS foil were replaced with alternatives that are highly conductive, lightweight, and foldable. A feasibility test was performed using CNTs from Brewer Science Inc., which were applied on a SS foil (10 nm) coin having a thickness of ca. 450 nm and a sheet resistance of 45 Ohm/sq. A type I coin cell was fabricated using metallic conductive EMPAC™ 1003 spin-coated on the CNT layer and 0.5M Li-IM in EMI-IM:PC (1:1). FIG. 40 illustrates a diagram of the coin cell. FIGS. 41-42 show the electrochemical activity in a CV curve and potential profiles in an Arbin tester at 0.1 mA, respectively.

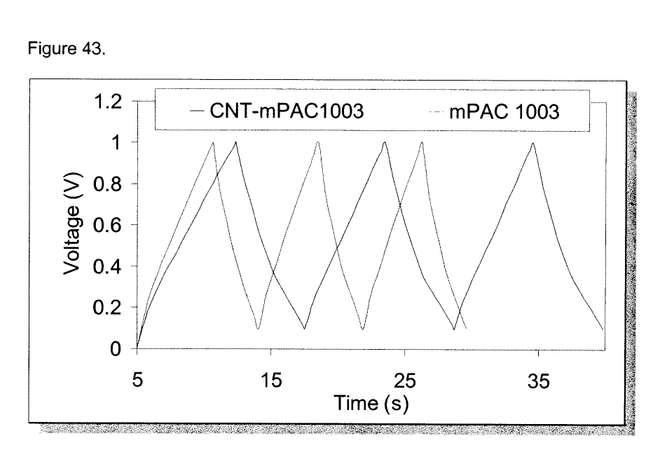

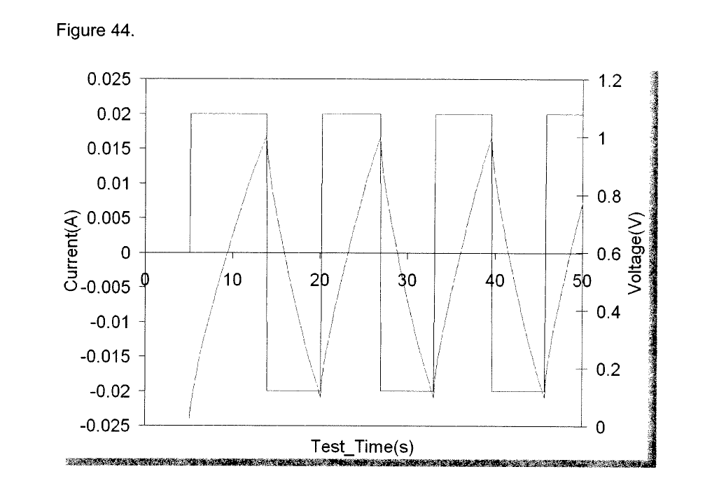

The coin cells were engaged in an Arbin tester, having an extensive cycling test over 3000 cycles. The results are summarized in FIG. 43 and Table 17. The use of a CNT layer enhanced energy in the C-DC cycle test. The coin cell formed a charge-transporting, CNT-based highway between the metallic conductive EMPAC™ 1003 and the SS foil coin, which resulted in an enhancement of the energy. In fact, there was found to be a synergistic effect based upon the large surface area of the metallic EMPAC™ 1003 layer that may be a result of the construction of the interfacial gap between the polymer layer and the CNT layer.

TABLE 17
Charging performance of coin cells that used CNT-metallic
EMPAC ™ 1003 layer versus EMPAC ™ 1003 layer

| | | | Charging | | DC | | Cycling |
|---|---|---|---|---|---|---|---|
| | Voltage | Current | Energy | Charging | ESR | Charging | Stability |
| Samples | (V) | (mA) | (J) | Cp (mF) | (Ohm) | Time (s) | (%) |
| CNT- | 1/0.1 | 2.5 | 0.013 | 16.55 | 1.145 | 5.95 | 89 |
| EMPAC ™ | | | | | | | |
| 1003 | | | | | | | |
| EMPAC ™ | 1/0.1 | 2.5 | 0.01 | 12.23 | 1.112 | 4.41 | 93 |
| 1003 | | | | | | | |

*Active layer mass: CNT-EMPAC ™ 1003 (0.45 mg); EMPAC ™ 1003 (0.44 mg); coin (0.75″ Dia.)/** EMPAC ™ 1003 spun-coated at 1000 rpm for 30 s and treated with Thymol and secondary dopants/*** 0.5M Li-BTI in EMI-IM: PC/****2002nd cycle; Cycling stability = Cp (@2002nd cycle) * 100/Cp (@3000th cycle).

TABLE 18
Comparison of coin cell performance at charging process

| | |
|---|---|
| CNT-EMPAC ™ 1003 coin cell | EMPAC ™ 1003 coin cell |

| | | | |
|---|---|---|---|
| 16.55 | mF | 12.23 | mF |
| 0.013 | J | 0.01 | J |
| 5.95 | s | 4.41 | s |
| 1.145 | Ω | 1.112 | Ω |

| | |
|---|---|
| 89% | 93% |

### EXAMPLE 7

In this example, CNTs were blended with an EMPAC™ 1003 solution, using a micro fluid processor, to observe additional contributions of CNTs for enhancing device performance. Mass of the resultant CNT incorporated EMPAC™ 1003 film spin coated using the solution of a concentration of 8.7% was observed to be equivalent to the mass of EMPAC™ 1003 film that has concentration of 20%, indicating the high level of dispersity of CNT in EMPAC™ 1003 solution.

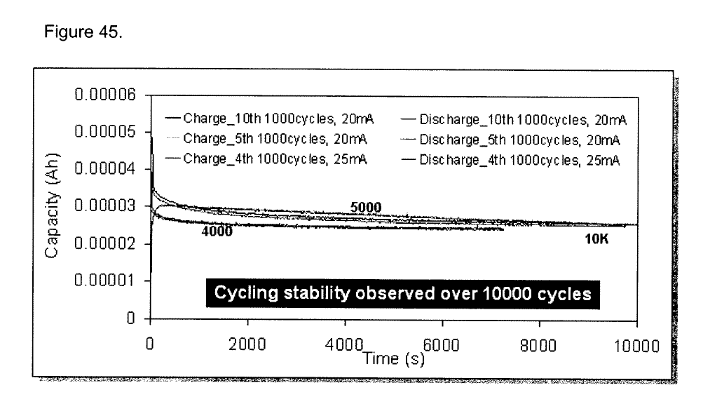

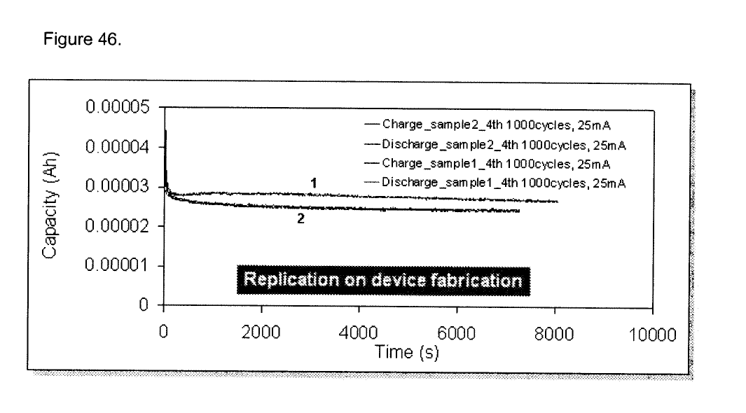

The C-DC test on the open cell using CNT-EMPAC™ 1003 blends was noticeably stable as depicted in FIGS. 45-46. The resultant summary for the performance is described in Table 19, where charging energy of ca.150 mF from one single cell was achieved even after 10,000 C-DC cycles.

TABLE 19
Charging performance of open cells that used CNT-EMPAC ™
1003 layer at the 10^{th} 1000 C-DC cycles

| | Volt- | | Charging | | | |
|---|---|---|---|---|---|---|
| | age | Current | Energy | Charging | DC ESR | Charging |
| Samples | (V) | (mA) | (J) | Cp (mF) | (Ohm) | Time (s) |
| 1 | 1/0.1 | 20 | 0.082 | 145.48 | 0.463 | 6.55 |
| 2 | 1/0.1 | 20 | 0.084 | 149.62 | 0.461 | 6.73 |

*Internal active layer mass: CNT-EMPAC ™ 1003 (24 ± 0.54 mg), solid contents of BSI CNT (0.45%)-EMPAC ™ 1003 solution: 8.7 w/w %/** EMPAC ™ 1003 dip-coated and treated with Thymol and secondary dopants/*** 0.5M Li-BTI in EMI-IM: PC/****Active layer (2″ × 2″ & polymer 2 × 1.75″/Astral Tech 0.5 mil)

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions without departing from the scope of the invention, it is intended that all matter contained in the above description and shown in the accompanying drawings shall be interpreted as illustrative and not in a limiting sense.

What is claimed is:

1. An inherently conductive polymer comprising a conductive polymer, carbon nanotubes, and a primary dopant.

2. The inherently conductive polymer of claim 1 wherein the primary dopant is dinonylnaphthalene sulfonic acid.

3. The inherently conductive polymer of claim 1 wherein the conductive polymer is selected from the group consisting of polyaniline, polypyrrole, polyacetylene, polythiophene, and poly(phenylene vinylene).

4. The inherently conductive polymer of claim 1 wherein the conductive polymer is a substituted or unsubstituted aniline, pyrrole, or thiophene.

5. The inherently conductive polymer of claim 1 wherein the conductive polymer is polyaniline.

6. The inherently conductive polymer of claim 5 wherein the polyaniline was formed via the addition of aniline to a solution and the amount of carbon nanotubes present is between about 0.1% and about 25% of the amount of aniline added.

7. The inherently conductive polymer of claim 5 wherein the polyaniline was formed via the addition of aniline to a solution and wherein the amount of carbon nanotubes present is between about 2% and about 20% of the amount of aniline added.

8. The inherently conductive polymer of claim 1 wherein the carbon nanotubes comprise single walled carbon nanotubes.

9. The inherently conductive polymer of claim 1 wherein the carbon nanotubes comprise multi walled carbon nanotubes.

10. The inherently conductive polymer of claim 1 wherein the carbon nanotubes are functionalized.

11. The inherently conductive polymer of claim 1 wherein the carbon nanotubes are hydrophilic.

12. The inherently conductive polymer of claim 1 wherein the inherently conductive polymer has a conductivity between about 25 and 100 S/cm.

13. The inherently conductive polymer of claim 1 wherein the inherently conductive polymer has a conductivity between about 30 and 75 S/cm.

14. The inherently conductive polymer of claim 1 wherein the inherently conductive polymer has a conductivity between about 40 and 60 S/cm.

15. The inherently conductive polymer of claim 1 wherein the inherently conductive polymer has a conductivity between about 40 and 50 S/cm.

16. An inherently conductive polymeric film comprising a conductive polymer, carbon nanotubes, and a primary dopant.

17. The film of claim 16 wherein the primary dopant is dinonylnaphthalene sulfonic acid.

18. The film of claim 16 wherein the conductive polymer comprises polyaniline.

19. An inherently conductive carbon paper comprising polyaniline, carbon nanotubes, and a primary dopant coated onto porous carbon paper.

20. A supercapacitor comprising:
a. a first substrate comprising a first and second surface;
b. a first electrode having a first and second side, wherein the first side is adjacent the second surface of the first substrate, and comprising an inherently conductive polymer, carbon nanotubes, and a primary dopant;
c. an electrolyte adjacent the second side of the first electrode;
d. a second electrode having a first side and a second side, wherein the first side is adjacent the second side of the first electrode and separated from the first electrode by the electrolyte, and comprising an inherently conductive polymer, carbon nanotubes, and a primary dopant; and
e. a second substrate having a first surface and a second surface, wherein the first surface is adjacent the second side of the second electrode.

21. The supercapacitor of claim 20 wherein the inherently conductive polymer is polyaniline.

22. The supercapacitor of claim 20 wherein the primary dopant is dinonylnaphthalene sulfonic acid.

23. The supercapacitor of claim 20 wherein the electrolyte is acidic.

24. The supercapacitor of claim 20 wherein the electrolyte is p-toluenesulfonicacid in 1-ethyl-3-methylimidazolium bis(triflouromethylsulfonyl)amide/propylene carbonate.

25. The supercapacitor of claim 20 wherein the supercapacitor is a coin cell supercapacitor.

26. The coin cell supercapacitor of claim 25 comprising a first layer of stainless steel foil, a second layer of carbon nanotubes coated onto the first layer, and a third layer of polyaniline coated onto the second layer.
